(19) United States
(12) Patent Application Publication
(10) Pub. No.: US 2008/0311315 A1
(43) Pub. Date: Dec. 18, 2008

(54) ANIMATED ARTIFICIAL FLOWER

(76) Inventor: Peter Marlow, Granada Hills, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/139,193

(22) Filed: Jun. 13, 2008

Related U.S. Application Data
(60) Provisional application No. 60/934,405, filed on Jun. 13, 2007.

(51) Int. Cl. A41G 1/00; A01N 3/00

(52) U.S. Cl. 428/24

(57) ABSTRACT

A device which simulates natural flowering actions, including growth and efflorescence, is actuated by partial immersion of a stem into a liquid. In one embodiment, a piston slidably disposed within the stem is driven upwardly by the bias force of a resilient spring while an agent which impedes the piston motion dissolves in the liquid. In another embodiment, the piston is pushed upwardly by an expansive force of a liquid-absorbing material. An inner stem, operably connected to the piston, is slidably disposed within the stem and projects upwardly therefrom. A simulated corolla is attached to the inner stem and gradually opens and rotates during an ascent thereof. The petals of the corolla, in one embodiment, open with individual variations in starting time, rate and extent. As the corolla opens, a surprise object, gradually ascending on a presentation platform, is revealed.

### CROSS-REFERENCE TO RELATED APPLICATIONS

This application claims the benefit of U.S. Provisional Patent Application No. 60/934,405, filed Jun. 13, 2007, the entire disclosure of which is hereby incorporated by reference herein and should be considered a part of this specification.

### BACKGROUND OF THE INVENTION

1. Field of the Invention

The present invention relates generally to artificial flowers, and more specifically to an animated artificial flower device which, upon partial immersion in a liquid, simulates natural flowering actions and reveals a surprise object.

2. Description of the Related Art

Artificial flowers are commonly used as indoor decorative accessories. Natural flowers, whether planted, potted, or cut for use in a vase, also have wide appeal as an enhancement to all sorts of environments. Natural flowers share many of the advantages of artificial flowers, and, if cared for appropriately, are capable of growing and blooming in a pleasing way. Many thousands of people enjoy receiving flowers in one form or another on a daily basis throughout the world.

### SUMMARY OF THE INVENTION

In view of the circumstances noted above, an aspect of at least one of the embodiments disclosed herein is to provide an animated artificial flower device that has the appearance of a long-stem cut flower and that can simulates growth and blooming when placed in water or other liquid. In some embodiments, the artificial flower can provide a gradual or controlled presentation of a blooming flower and can be reusable. Moreover, in some embodiments, the artificial flower device can enable the presentation of a gift or surprise object concealed within the closed flower.

In accordance with one embodiment, an animated artificial flower device is provided. The device comprises a stem, a piston movably disposed within the stem and subject to a bias force, the piston being actuatable to move within the stem at a controlled rate. The device also comprises a presentation platform operatively coupled to the piston, the presentation platform being movable relative to the stem and configured to hold a surprise object thereon. The movement of the piston by said bias force causes an upward extension of the platform relative to the stem so as to reveal said surprise object.

In accordance with another embodiment, a method for operating an animated artificial flower is provided. The method comprises actuating a piston movably disposed within a stem of the artificial flower to move relative to the stem at a controlled rate, and actuating a presentation platform operatively coupled to the piston to extend upwardly relative to the stem of the artificial flower to reveal a surprise object coupled to the presentation platform.

In accordance with still another embodiment, an animated artificial flower device is provided. The device comprises a stem means for providing a mechanical reference housing, a resilient spring means for providing a bias force, a piston means for movably transmitting the bias force of the resilient spring means, a piston chamber means for containing an impeding agent within the stem means, a retaining stop means for rigidly opposing the bias force of the resilient spring means within the stem means as transmitted by the piston means through an impeding agent occupying the piston chamber means, and an aperture means, for admitting a select liquid into the stem means and into the piston chamber means, to thereby diminish the impeding effectiveness of an impeding agent. A controlled motion is produced in the piston means, relative to the stem means, by the bias force of the resilient spring means, through a gradual reduction in the effective size of an impeding agent (the impeding agent occupying the piston chamber means interposing the piston means and the retaining stop means, having been previously inserted therein), which reduction follows an exposure of the piston chamber means to a select liquid through the aperture means, and progresses at a rate substantially commensurate to the rate of reduction of the effective size of the impeding agent.

In accordance with yet another embodiment, an animated artificial flower device is provided. The device comprises a stem, a resilient spring, a piston chamber within the stem capable of being occupied by an impeding agent, a piston slidably disposed within the stem, biased upwardly by the resilient spring, and at a lowest position thereof, defining a lower end of the piston chamber, a retaining stop within the stem, defining an upper end of the piston chamber and rigidly opposing the bias force of the spring as transmitted by the piston through an impeding agent occupying the piston chamber, and at least one aperture in the stem through which a select liquid can enter into the piston chamber to thereby diminish the impeding effectiveness of an impeding agent. Upon an exposure of a portion of the stem comprising the piston chamber to a select liquid (an impeding agent occupying the piston chamber interposing the piston and retaining stop, having been previously inserted therein), the select liquid enters into the piston chamber through the aperture, gradually reduces the effective size of the impeding agent, and the piston moves upwardly at a rate substantially commensurate to the rate of the reduction of the effective size of the impeding agent, producing a controlled motion thereof relative to the stem.

In accordance with another embodiment, a method for presenting animation in an artificial flower device is provided. The method comprises exposing at least a portion of a stem to a select liquid, the device comprising the stem and at least one petal, the petal positionable in a closed state and an opened state, a portion of the petal resembling a portion of a petal of a natural flower, a portion of the stem resembling a portion of a stem of a natural flower. The method also comprises actuating an animation activity of the device, drawing from a force generating potential of a member configured within the artificial flower to perform the animation activity automatically, and opening the petal in accordance with the animation activity.

In accordance with yet another embodiment, an animated flower device is provided. The device comprises a stem, at least one aperture in the stem, excluding the top thereof, included for the purpose of admitting a select liquid therein, at least one petal, positionable in a closed state and an opened state, and a member capable of providing, upon an actuating event, a mechanical force used to perform an animation activity, the actuating event comprising an admittance of a select liquid into the stem through the aperture therein, the animation activity comprising moving the petal from the closed state to the opened state. Upon an exposure of the stem to a select liquid, the select liquid enters into the stem through the aperture, and thereby actuates the performance of the animation activity, opening the petal.

In accordance with still another embodiment, an animated artificial flower device is provided. The device comprises a stem, a portion of the stem resembling a portion of a stem of a natural flower, and a perianth capable of ascending relative to the stem, parts of which are slidably disposed outside an upper portion of the stem, a portion of the perianth resembling a portion of a perianth of a natural flower. As the perianth ascends, a portion of the stem concealed by the perianth is gradually revealed, presenting a simulation of natural flower growth.

In accordance with another embodiment, a method for presenting animation in an artificial flower device is provided. The method comprises lifting a perianth relative to a stem, a portion of the perianth resembling a portion of a perianth of a natural flower, a portion of the stem resembling a portion of a stem of a natural flower, with parts of the perianth slidably disposed outside an upper portion of the stem. As the perianth ascends, a portion of the stem concealed by the perianth is gradually revealed, presenting a simulation of natural flower growth.

In accordance with still another embodiment, an animated artificial flower device is provided. The device comprises a first stem, a portion of the first stem resembling a portion of a stem of a natural flower, a second stem, slidably disposed relative to the first stem, capable of ascending relative to the first stem, and at least one petal, the petal operably connected to the second stem, positionable in a closed state and an opened state, presented and maintained in a substantially closed state during an initial portion of the ascent of the second stem, and configured to open following the initial portion of the ascent of the second stem, a portion of the petal resembling a portion of a petal of a natural flower. During the initial portion of the ascent of the second stem, to simulate natural flower growth, the petal is presented substantially closed, and subsequently, following the initial portion of the ascent of the second stem, the petal is opened.

In accordance with still another embodiment, a method for presenting animation in an artificial flower device is provided. The method comprises lifting a second stem relative to a first stem, a portion of the first stem resembling a portion of a stem of a natural flower, presenting at least one petal, the petal operably connected to the second stem, positionable in a closed state and an opened state, a portion of the petal resembling a portion of a petal of a natural flower. The method also comprises maintaining the petal in a substantially closed state during an initial portion of the ascent of the second stem, and opening the petal following the initial portion of the ascent of the second stem. During the initial portion of the ascent of the second stem, to simulate natural flower growth, the petal is presented substantially closed, and subsequently, following the initial portion of the ascent of the second stem, the petal is opened.

In accordance with another embodiment, an animated artificial flower device is provided. The device comprises a first stem, a portion of the first stem resembling a portion of a stem of a natural flower, a second stem, slidably disposed relative to the first stem, capable of ascending relative to the first stem, at least one petal, operably connected to the second stem, positionable in a closed state and an opened state, a portion of the petal resembling a portion of a petal of a natural flower, and a helical screw thread and mating member configured interposing the first stem and second stem. As the second stem ascends, the petal rotates about a longitudinal axis of the first stem.

In accordance with yet another embodiment, a method for presenting animation in an artificial flower device is provided. The method comprises lifting a second stem relative to a first stem, a portion of the first stem resembling a portion of a stem of a natural flower, and rotating the second stem and at least one petal about a longitudinal axis of the first stem as the second stem ascends, the petal operably connected to the second stem, positionable in a closed state and an opened state, a portion of the petal resembling a portion of a petal of a natural flower.

In accordance with still another embodiment, an animated artificial flower device is provided. The device comprises a stem, a portion of the stem resembling a portion of a stem of a natural flower, a petal hinge stage, at least one petal, operably connected to the petal hinge stage, positionable in a closed state and an opened state, biased in a closed state, constituting a third-class lever, the operable connection of the petal to the petal hinge stage constituting a fulcrum of the third-class lever, a visually engaging upper rim of the petal constituting an output load of the third-class lever, a portion of the petal resembling a portion of a petal of a natural flower. The device also comprises a petal control arm capable of applying a downward force relative to the petal hinge stage at an input effort position of the third-class lever comprising the petal, whereby the petal is opened.

In accordance with another embodiment, an animated artificial flower device is provided. The device comprises a calyx, a portion of the calyx resembling a portion of a calyx of a natural flower, a petal hinge stage, slidably disposed within the calyx and capable of ascending relative to the calyx, at least two petals, a first petal and a second petal, each petal operably connected to the petal hinge stage, positionable in a closed state and an opened state, biased in an opened state, opposed from opening by the calyx when positioned substantially within the calyx, and configured to open as the petal hinge stage ascends. A portion of each petal resembles a portion of a petal of a natural flower. The device further provides a position of the petal hinge stage relative to the calyx wherein the first petal is partially opened and the second petal is closed, sufficient to render a substantial difference in a starting time of opening among the petals, and at a position of the petal hinge stage wherein the first petal and the second petal are each partially opened, a degree of opening of the first petal that differs substantially from the degree of opening of the second petal, the difference in the degree of opening of the petals sufficient to render a substantial difference in at least one of a rate and an extent of opening among the petals.

In accordance with another embodiment, a method for presenting animation in an artificial flower device is provided. The method comprises positioning at least two petals, a first petal and a second petal, in a closed state, a portion of each petal resembling a portion of a petal of a natural flower, moving the first petal to an opened state, and moving the second petal to an opened state. The manner of the opening of the second petal differs substantially from the manner of the opening of the first petal, the difference in manner of opening among the petals comprising at least one of the properties of starting time, rate and extent of opening of the petals.

In accordance with still another embodiment, a method for presenting a surprise gift is provided. The method comprises associating a surprise gift to an artificial flower, the artificial flower comprising a stem and at least one petal, the petal positionable in a closed state and an opened state, at least partially concealing the surprise gift with the petal in the closed state, actuating an animation activity of the artificial flower by exposing a portion of the stem to a select liquid, opening the petal in accordance with the animation activity, and revealing the surprise gift.

In accordance with yet another embodiment, a method for presenting a surprise gift is provided. The method comprises associating a surprise gift to an artificial flower, the artificial flower comprising at least one petal, the petal positionable in a closed state and an opened state, a portion of the petal resembling a portion of a petal of a natural flower, at least partially concealing the surprise gift with the petal in the closed state, actuating an animation activity of the artificial flower, drawing from a force generating potential of a member configured within the artificial flower to perform the animation activity automatically, opening the petal in accordance with the animation activity, and revealing the surprise gift.

In accordance with another embodiment, a method for presenting a surprise gift, is provided. The method comprises associating a surprise gift to an artificial flower, the artificial flower comprising at least one petal, a portion of the petal resembling a portion of a petal of a natural flower, at least partially concealing the surprise gift with the petal, actuating an animation activity of the artificial flower, drawing from a force generating potential of a member configured within the artificial flower to perform the animation activity automatically, gradually lifting the surprise gift relative to the petal in accordance with the animation activity, and revealing the surprise gift.

In accordance with still another embodiment, a method for presenting animation in an artificial flower device is provided. The method comprises actuating an animation activity of an artificial flower device, the artificial flower comprising a stem and at least one petal. The method also comprises, in accordance with the animation activity, performing at least one of: lifting the petal relative to the stem, and moving the petal from a closed state to an opened state. The method also comprises, in accordance with the animation activity, activating at least one of: an electronic and a mechanical apparatus, the apparatus providing at least one of: illumination, sound generation, moving parts and a release of a fragrant substance.

In accordance with another embodiment, a method for presenting a surprise gift is provided. The method comprises associating a surprise gift to an artificial flower, the artificial flower comprising at least one petal, concealing the surprise gift with the petal, actuating an animation activity of the artificial flower, and in accordance with the animation activity, performing at least one of: moving the petal from a closed state to an opened state, and lifting the surprise gift relative to the petal. The method also comprises, in accordance with the animation activity and within at least one of: the surprise gift and the artificial flower, activating at least one of: an electronic and a mechanical apparatus, the apparatus providing at least one of: illumination, sound generation, moving parts and a release of a fragrant substance.

In accordance with another embodiment, a method for presenting a surprise gift is provided. The method comprises associating a surprise gift to an artificial flower, the artificial flower comprising at least one petal, at least partially concealing the surprise gift with the petal, revealing the surprise gift, dissociating the surprise gift from the artificial flower, and upon dissociating the surprise gift from the artificial flower, activating a feature within at least one of: the surprise gift and the artificial flower, the feature including at least one of: an electronic and a mechanical apparatus, the apparatus providing at least one of: illumination, sound generation, moving parts and a release of a fragrant substance.

In accordance with still another embodiment, an animated artificial flower device is provided. The device comprises a corolla comprising at least one petal, the petal positionable in a closed state and an opened state, a portion of the petal resembling a portion of a petal of a natural flower, a cavity defined within the corolla, when the petal is in the closed state, for the purpose of at least partially concealing a surprise gift. The device also comprises a member capable of providing a mechanical force, the energy to produce the mechanical force capable of being stored indefinitely and released, upon an actuating event, to perform an animation activity, the animation activity comprising automatically moving the petal from the closed state to the opened state.

### BRIEF DESCRIPTION OF THE DRAWINGS

These and other features, aspects and advantages of the present invention will now be described in connection with preferred embodiments of the invention, in reference to the accompanying drawings. The illustrated embodiments, however, are merely examples and are not intended to limit the invention. The drawings include the following 35 figures, in which like numerals indicate like parts.

FIG. 1 is a front perspective view of one embodiment of an animated artificial flower device in a closed state.

FIG. 2 is a cross-sectional view of the artificial flower of FIG. 1 taken generally along line 2-2, and illustrating various internal component parts of the device, the device in the closed state.

FIG. 3 is a cross-sectional view of the artificial flower of FIG. 1 taken generally along line 2-2, and illustrating various internal component parts of the device, the device in the open state.

FIG. 4 is an enlarged cross-sectional view of area “4” of FIG. 2.

FIG. 5 is an enlarged cross-sectional view of area “5” of FIG. 3.

FIG. 6 is a partially fragmented and sectioned, perspective and exploded view of selected components of the artificial flower of FIG. 1.

FIG. 7 is a partially fragmented and sectioned perspective view of the components of FIG. 6 assembled, the device in the closed state.

FIG. 8 is a partially fragmented and sectioned perspective view of the components of FIG. 6 assembled, the device in the opened state.

FIG. 9 is a partially fragmented, perspective and exploded view of an example stem and sleeve used with the artificial flower of FIG. 1.

FIG. 10 is a fragmented perspective view of the stem and sleeve of FIG. 9 positioned to enable access to the piston chamber.

FIG. 11 is a fragmented perspective view of the stem and sleeve of FIG. 9 illustrating rotation of the sleeve to close access to the piston chamber.

FIG. 12 is an enlarged cross-sectional view of one embodiment of a brake assembly usable with the artificial flower of FIG. 1, the brake assembly in a non-braking configuration.

FIG. 13 is a side elevational view taken generally along line 13-13 of FIG. 12.

FIG. 14 is a partially sectioned view taken generally along line 14-14 of FIG. 12.

FIG. 15 is an enlarged cross-sectional view of the brake assembly usable with the artificial flower of FIG. 1, the brake assembly in a braking configuration.

FIG. 16 is a side elevational view taken generally along line 16-16 of FIG. 15.

FIG. 17 is a partially sectioned view taken generally along line 17-17 of FIG. 15.

FIG. 18 is a cross-sectional view of another embodiment of an artificial flower device in a closed state.

FIG. 19 is an enlarged cross-sectional view of area “19” of FIG. 18, illustrating use of an inner stem limit pin.

FIG. 20 is a cross-sectional view of the artificial flower of FIG. 18 in an opened state.

FIG. 21 is an enlarged cross-sectional view of area “21” of FIG. 20, illustrating the inner stem limit pin engaging an inner stem pin groove of the device.

FIG. 22 is an enlarged cross-sectional view of area “22” of FIG. 20, illustrating another embodiment of a brake assembly in a non-braking configuration.

FIG. 23 is a perspective view of the brake assembly of FIG. 22 in a non-braking configuration.

FIG. 24 is a perspective view of the brake assembly of FIG. 22 in a braking configuration.

FIG. 25 is a cross-sectional view taken generally along line 25-25 of FIG. 24.

FIG. 26 is a cross-sectional view of yet another embodiment of an artificial flower device in a closed state.

FIG. 27 is a cross-sectional view of the artificial flower of FIG. 26 in an opened state.

FIG. 28 is a partially fragmented cross-sectional view of yet another embodiment of an artificial flower device in a closed state.

FIG. 29 is a partially fragmented cross-sectional view of the artificial flower of FIG. 28 in an opened state.

FIG. 30 is a partially fragmented cross-sectional view of yet another embodiment of an artificial flower in a closed state.

FIG. 31 is a partially fragmented cross-sectional view of the artificial flower of FIG. 30 in an opened state.

FIG. 32 is a partially fragmented cross-sectional view of yet another embodiment of an artificial flower in a closed state.

FIG. 33 is a partially fragmented cross-sectional view of the artificial flower of FIG. 32 in an opened state.

FIG. 34 is a cross-sectional view of yet another embodiment of an artificial flower in a closed state.

FIG. 35 is a cross-sectional view of the artificial flower of FIG. 34 in an opened state.

### DETAILED DESCRIPTION OF THE PREFERRED EMBODIMENTS

### Introduction

Artificial flowers, though available in a large assortment of types and forms, are almost universally static. The ubiquity of static artificial flowers, despite some being quite attractive, has made them familiar fixtures upon which little attention is focused. They can beautify a setting or evoke feelings of tranquility, but they do not deliver a dynamic or captivating interactive experience. Certainly, an observer has no expectation of animation therefrom in the form of realistic growth or blooming.

As noted above, natural flowers have certain advantages with respect to artificial flowers. For example, if cared for appropriately, natural flowers are capable of growing and blooming in a pleasing way. However, because such vitality progresses very slowly, it is difficult to observe. Furthermore, the beauty of natural flowers quickly fades. Because they are so commonplace, natural flowers, like static artificial flowers, are generally not objects of sustained or exceptional interest.

Even though many people enjoy receiving flowers, their delight typically peaks at the initial presentation and quickly passes. The flowers are soon forgotten. There is no expectation of later discovery of additional excitement originating therewith.

There exists a continuing human need for objects that delight and enchant by their ability to transcend expectations. An artificial flower that gradually grows, blooms and delicately reveals a surprise gift from within its corolla satisfies such a need, and more so if the recipient is invited to participate by providing the type of care and handling normally given a natural flower. The experience can be further enhanced if the actions of the flower are rendered by a mechanism that is not readily apparent or easily understood.

There exist conventional artificial flowers that simulate blooming, present a surprise gift, or use water as an actuating component. These are typically driven by relatively large machinery appending the stem, usually concealed in a flower pot or other base. In addition to the inconvenience posed by the size and weight of many of these bases, the users of such artificial flowers cannot enjoy the degree of mystery and wonder that can entertain users of an animated artificial flower having no base machinery. Indeed, some bases simply cannot hide their mode of operation, such as when the application of manual or electric force is required. Manual actuation of animation in an artificial flower device, even in the absence of a large base is generally undesirable where a realistic or more intriguing experience by the recipient is intended.

A large attached base also precludes the distinct advantage of being able to present the device as a long-stemmed cut flower. The care and handling of an animated artificial flower in a manner not unlike that given a natural flower involves a recipient in a rewarding adventure that adds to the satisfaction of the experience. Particularly, actuation of the animation activities of the artificial flower by nothing more than the placement of its stem in a container of water is advantageous. Certain conventional animated artificial flowers are incapable of providing this experience because water must be applied into or through the exposed center of its corolla, whereupon it quickly opens. For this reason, it is also impractical for such devices to conceal a surprise gift.

The slow and gradual ascent of a surprise gift from within an opening corolla is a feature that transforms an animated artificial flower from a pleasant toy to a more refined and stylish instrument capable of making an elegant presentation. Reusability in such a device adds still more to its value. It further defies expectations and excites the imagination that such a device could be prepared for reuse by refilling a small chamber within the stem with a common ingredient, such as granulated sugar.

Accordingly, disclosed herein are various embodiments of artificial flower devices that can faithfully recreate the general appearance of a long-stemmed cut flower and that simulate gradual blooming when placed in water or other liquid. In certain embodiments, the flower can additionally, alternatively or optionally lift a surprise object from within its corolla. In certain embodiments, the flower is conveniently reusable. Certain embodiments provide these features in addition to other unique and novel features.

### Terminology

By being labeled with terms commonly understood to identify parts of a natural flower, some of the component parts of the embodiments are suggested to resemble, but are not limited to, some of the visual aspects and mechanical attributes of such parts of a natural flower. For example, except when modified by the word “natural”, the term “petal” identifies a component part of the embodiments which can resemble a natural petal. Furthermore, except when modified by the word “natural”, the term “flower” identifies one or more of the several example embodiments disclosed herein. Continuing the example, the terms “natural petal” or “natural growing flower” identify matter having a biological origin.

The words “open” and “closed,” when used in connection with the words “petal” and “corolla” in phrases such as “closing the petals,” “an opening force to the petals,” “to open the corolla” and “closed-corolla,” indicate a state of or phase in the development of animation in the petals or corolla. The word “open” indicates the petals or corolla in a state generally resembling a mature natural flower at the peak of anthesis, the petals projected outwardly at or toward their maximum extension. The word “closed” indicates the petals or corolla in a state generally resembling a maturing natural flower immediately prior to the start of anthesis, the petals drawn together inwardly at or toward their minimum extension. The terminology includes the words specifically mentioned above and their derivatives.

The words “open” and “closed,” when used herein throughout the specification and appended claims in connection with the word “flower” in phrases such as “the flower in a closed state,” “to open the flower,” “the flower is thereby closed” and “the opened flower,” indicate a starting (e.g., “closed”) or ending (e.g., “open”) state in the development of animation in the flower and is not limiting. The terminology includes the words specifically mentioned above and their derivatives.

Many of the component parts of the embodiments described herein are shown in a simplified form to facilitate understanding. During the process of manufacturing and assembling these embodiments, the use of adhesive materials and methods individually or in combination, such as glues, epoxies, solvent based adhesives, rivets, nuts, bolts, snap fits, press fits, locking features, screw threads, ultrasonic welding, and the like, to join multiple subunits of a component part shown or described as a single, integrally formed unit, can be used. Conversely, adjoining component parts, each shown or described as separate or independent units, can optionally be manufactured and assembled as one single, integrally formed unit.

Unless otherwise specified, certain terminology is used to indicate an adherence, link or association between two or more component parts for convenience only and is not limiting. The words “connect,” “attach,” “bond,” “fasten,” “join,” “affix” and “secure,” their derivatives and words of similar meaning designate adherence, whether durable, transitory, fixed or movable, or otherwise. This could be accomplished using a variety of different techniques, such as the use of: an adhesive material or method (some examples of which are listed in the preceding paragraph); and/or a mechanical link between two or more discrete component parts with or without the intermediate use of additional component parts, whether referenced or not; and/or an intrinsic association between two or more sections of a single, integrally formed component part that is one unit; and/or a combination of the above.

Component parts described and/or labeled as a “cable” or a “line” are typically a type of flexible thread or cord, but can also be a rigid rod or shaft, or can comprise other properties. The cable or line can comprise, but is not limited to, materials such as stainless steel, steel, brass, silk, nylon, polyester, polyethylene, polypropylene, polyvinyl chloride, acrylonitrile butadiene styrene, and the like. The cable or line can be monofilament or multifilament, rigid or flexible, elastic or unyielding, coarse or fine, plated, unplated, coated, uncoated, uniform, a combination or composite of various materials, and the like.

The words “right,” “left,” “front,” “rear,” “lower” and “upper” designate directions in the drawings to which the reference is made, or in the referenced embodiments when positioned as suggested by the drawings and descriptions thereof. The words “vertical” and “horizontal” designate, respectively, a general alignment to the upper/lower direction and a general perpendicularity thereto. The words “inwardly” and “outwardly” designate all directions toward and away from, respectively, the geometric center of the applicable parts or embodiments, and unless otherwise noted, apply to a generally horizontal plane. The terminology includes the words specifically mentioned above, their derivatives and words of similar meaning.

Unless otherwise noted, the meanings of words which designate or describe geometric figures, shapes and structures, such as, “round,” “tube,” “circle,” “square,” “rectangles” “ellipse,” “cylinder,” “sphere,” “cube,” “torus,” “globe,” “encircle,” “diameter,” “cone,” “radius” and “circumference,” include their literal meaning, as well as figures, shapes and structures that can be imperfect, irregular, asymmetric or embellished. The terminology includes words which designate or describe geometric figures, shapes and structures, their derivatives and words of similar meaning.

References are made herein to an “impeding agent”. An impeding agent is a substantially solid or rigid material which can occupy a volume to block or impede motion of a member within the volume, and, by an exposure to a select liquid, dissolve, chemically react, effervesce, disintegrate, soften, collapse, break down, or otherwise change from the solid state or rigid structure thereof to a state or structure which allows the motion of the member within the volume. One function of an impeding agent is to block animation of a mechanism prior to an exposure of the impeding agent to the select liquid, whereupon, following an exposure of the impeding agent to the select liquid, as the impeding agent gradually loses its solid state or rigid structure, the action of the mechanism proceeds at a rate commensurate to a reduction in the effective size, either by solid volume or rigid shape, of the impeding agent.

The impeding agent can be a single one-piece unit or a measure of a loose material in a fine particulate, medium granular or coarse pellet form. The impeding agent can also be a combination of a one-piece unit and a measure of material, and can also comprise other forms. The one-piece unit can be homogenous, hollow, a rigid foam, a porous aggregate of dissimilar particles held together by a soluble binder, or can comprise other physical structure or structures. The impeding agent can comprise varying materials and/or densities to provide non-linear performance. The impeding agent can fully fill the volume or narrowly occupy the volume by only contacting the moving member at one end and an opposing wall of the volume at another end. The impeding agent can comprise forms such as a rolled tube, extruded rod, molded plug, beads, tablets, powder, grains, and the like. The impeding agent can comprise sugar, as it is readily available, safe, and dissolves at a reasonable rate. Of course, the impeding agent can comprise other ingredients, alone or in combination, such as soap, table salt, soluble paper, paper, soluble plastics (such as polyvinyl alcohol and polyvinylpyrolidone), gelatin, candy, flavored drink mix, and the like. For example, certain embodiments are usable to disperse a flavored drink mix into a pitcher of water for human consumption.

The impeding agent can comprise combinations of substances which chemically react when exposed to a select liquid. For example, a dry mixture of an acid and base, such as citric acid and sodium bicarbonate, when exposed to water, can effervesce, forming gas and other byproducts. A disintegrant, such as starch, cellulose, crosslinked polyvinyl pyrrolidone, sodium starch glycolate, and sodium carboxymethyl cellulosemethycellulose, can be employed to accelerate dissolution. A paper tube can be so formed and placed within the volume as to gradually soften and collapse, partially disintegrate or fully dissolve upon exposure to a select liquid. Insoluble remains and byproducts can be readily accommodated with small modifications in the design and method presented herein, for example, by providing an additional space therefor within the volume and by providing for the manual removal of the insoluble remains and byproducts from the volume after use.

The impeding agent can comprise two or more layers, the layers differing by properties such as material composition, material density, physical structure and structural rigidity. One layer can be partially or fully coated by, glazed by, packaged within or otherwise enclosed by another layer. Each layer can respond differently to an exposure by a select liquid. One layer can dissolve, chemically react, effervesce, disintegrate, soften, collapse, break down, or otherwise change from its solid state or rigid structure more quickly or readily than another layer. For example, a paper or soluble plastic tube can be a container for other soluble substances in a granular form, providing a convenient packaging and a way to delay the start of actuation. The combination impeding agent comprising the tube enclosure and soluble granules enclosed therein can be inserted into the volume as one unit. The tube enclosure can fully impede the development of motion within the volume for a set time during exposure to a select liquid until the tube dissolves, disintegrates or softens, collapses and/or breaks down, whereupon the motion of the member within the volume proceeds and is regulated by the dissolution of the granular contents previously enclosed within the tube.

The collapse of such an enclosure and the release of the contents thereof, the enclosure having a substantially smaller diameter than the volume, can provide a relatively rapid step function in the initial motion of the member within the volume. In addition to paper or plastic, soluble coatings or glazings comprising types of substances such as sugars, starches, proteins, fibers, gums, and varnishes, alone or in combination, can also be used to form an outer layer. The rigid structure of the impeding agent is maintained during the initial softening, disintegration or dissolution of the enclosing material during exposure to a select liquid, allowing little or no progress in the motion of the member within the volume. Upon the collapse, substantial disintegration or dissolution of the enclosing material, the rigid structure is lost and the motion of the member within the volume progresses while the previously enclosed material dissolves. Actuation of animation in the artificial flower can follow an exposure to a select liquid by a delay time set by design.

The meaning of the term “dissolve” shall be expanded to include chemically react, effervesce, disintegrate, soften, collapse, break down, or otherwise change from a solid state or rigid structure to a state or structure ineffective at providing a blocking or impeding function, and shall be understood in accordance with the specific impeding agent being contemplated. The derivatives of the term “dissolve,” including “solution,” “dissolution” and “dissolvable,” shall receive a comparably expanded understanding.

The term “select liquid” refers to a liquid in which the impeding agent being contemplated is soluble, or capable of chemically reacting, effervescing, disintegrating, softening, collapsing, breaking down, or otherwise being changed from a solid state or a rigid structure to a state or structure ineffective at providing a blocking or impeding function. The select liquid can comprise water or a solution thereof. The select liquid can also comprise non-aqueous liquids, such as oils or alcohols.

References are made herein to an “impellent”. As used herein, an impellent is a solid material which swells or expands upon absorption of a select liquid. In certain embodiments, the impellent impels action in a mechanism during an exposure of the impellent to the select liquid, wherein, as the impellent gradually swells or expands, it provides a pushing force on a member of the mechanism. The action of the mechanism proceeds at a rate commensurate to the swelling or expansion of the impellent. The impellent can comprise a single one-piece unit, and/or it can comprise a measure of a material in a powdered, granular or pellet form. In certain embodiments, the impellent can comprise superabsorbent hydrogels, crosslinked sodium polyacrylate, polyacrylamide, other hydrophilic polymers, a compressed porous regenerated cellulose sponge, and/or other hydrophilic or superabsorbent materials alone or in combination.

When used with reference to an impellent, the term “select liquid” further refers to a liquid capable of being absorbed by the impellent to cause a swelling or expansion of the impellent. For example, the select liquid can comprise water.

References are made herein to a “surprise object” or “surprise gift”. The terms are used interchangeably. The surprise object or surprise gift is an article having tangible substance that can be provided by the flower or manually associated to the flower by a user for any intent or purpose. The surprise object or surprise gift can be removable or can be durably attached to the flower, can comprise a mounting adapter, removable covering, openable container or other enclosure or housing, and is not limited and does not exclude any article or number of articles or combination of articles. For example, the surprise object or surprise gift can comprise a doll, figurine, animated fairy, toy animal, pieces of chocolate or candy, photograph, written message, invitation, airline tickets, coupon, container of perfume, air freshener gel, car key, watch, engagement ring, pair of earrings, and the like. In certain embodiments, the surprise object or surprise gift, mounting adapter and/or enclosure independently or interconnectedly can comprise an electric battery, switch, and/or electronic circuit and/or mechanical apparatus, to provide features such as illumination, sound generation, moving parts, release of a fragrant substance, and the like.

### Detailed Description of Selected Example Embodiments

As shown in the accompanying drawings, certain embodiments provide animation and the presentation of a surprise gift in an artificial flower device. In one embodiment, the device closely resembles a long-stemmed cut flower. A spring and piston driven mechanism actuated by placement of the stem into a select liquid is used to simulate natural flowering and other actions.

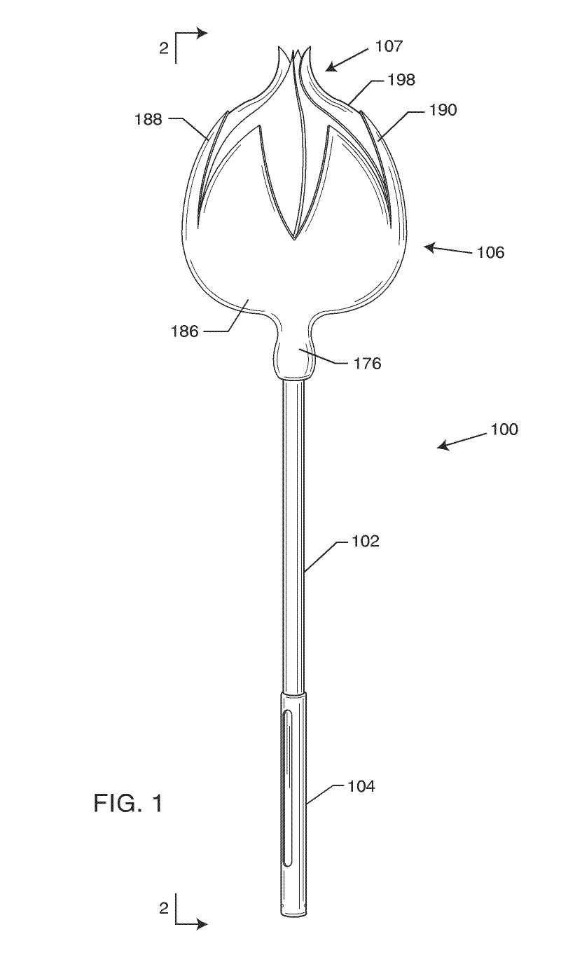

With reference now to FIG. 1, a perspective view of a device, a flower 100 is shown. The flower 100 includes a stem 102 which typically comprises an elongated tube. A sleeve 104, comprising a tube of slightly greater girth than the stem 102, is slidably and rotatably disposed over the lower part of the stem 102. Configured over the upper end of the stem 102 is a perianth 106 comprising a calyx 186, which further comprises thick sepals 188, thin sepals 190, and a receptacle 176. In certain embodiments, the calyx 186 comprises a plurality of sepals of varying thickness. A corolla 107 comprising at least one petal 198 is shown in FIG. 1 partially enclosed by the calyx 186.

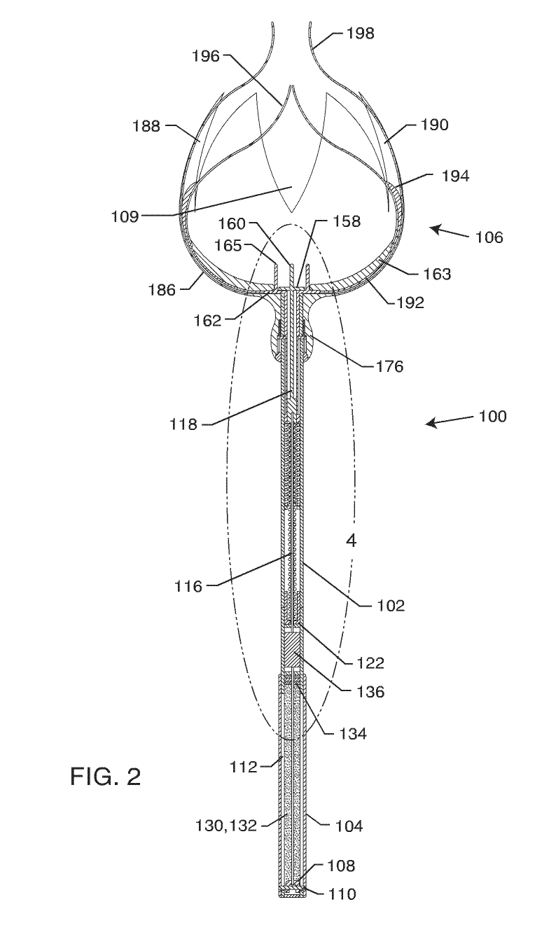

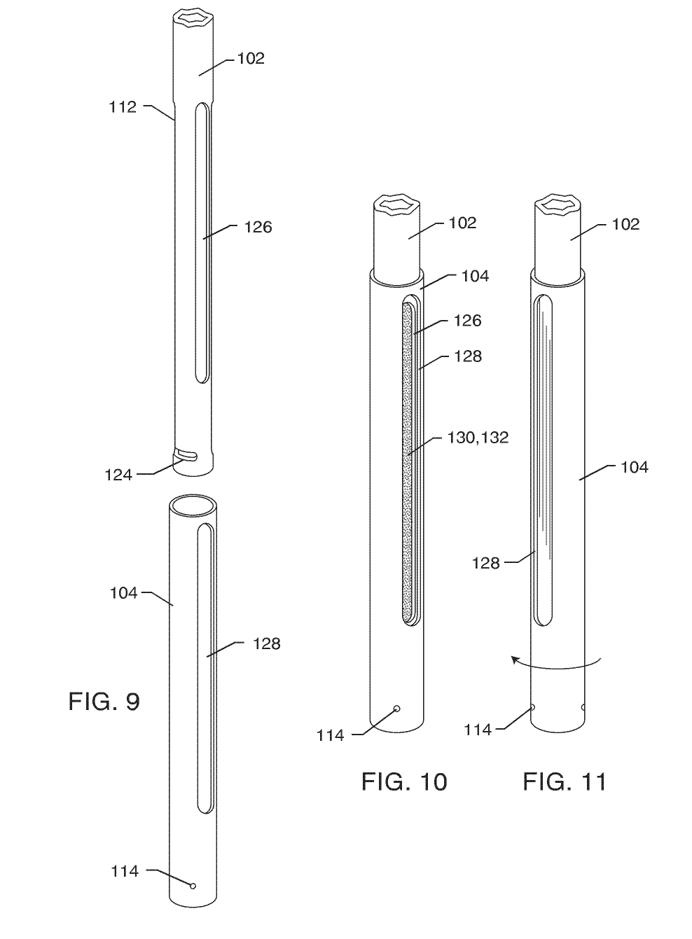

FIG. 2 illustrates a cross-sectional view taken generally along line 2-2 of FIG. 1, illustrating various internal component parts of the example device, as they are positioned and arranged in the closed state. A piston 108, typically comprising a generally cylindrical shape with a closed end, is slidably disposed within the tube of the stem 102. The piston 108 is attached to the sleeve 104 by a generally cylindrical piston pin 110 that extends horizontally through the piston 108, through two piston pin tracks 112 in the walls of the stem 102, and through the walls of the sleeve 104. As illustrated in FIG. 9, the walls of the sleeve 104 include piston pin apertures 114 that are positioned and dimensioned to receive the piston pin 110.

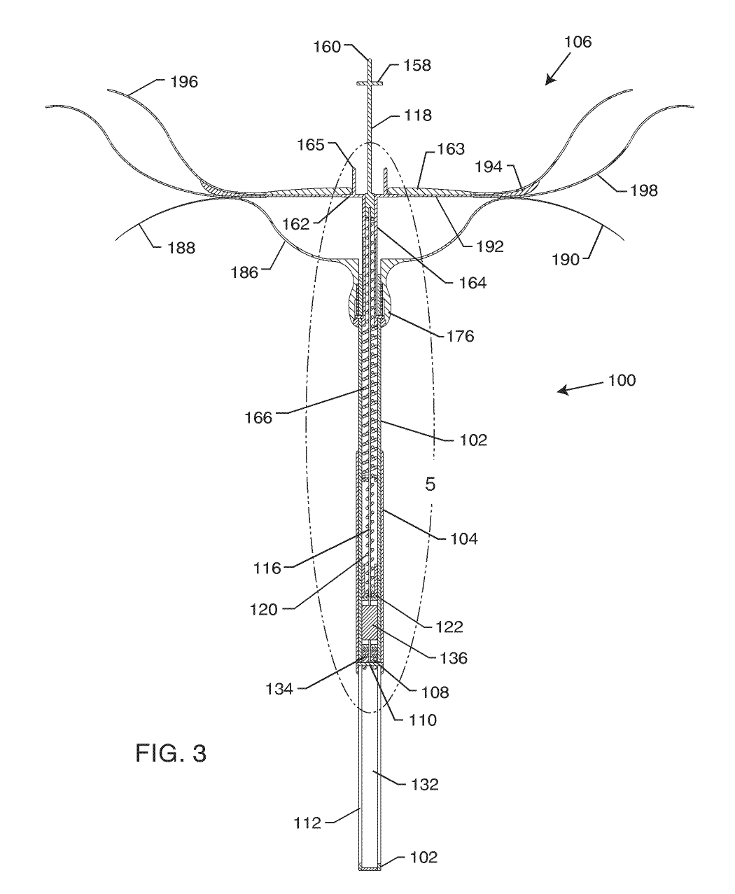

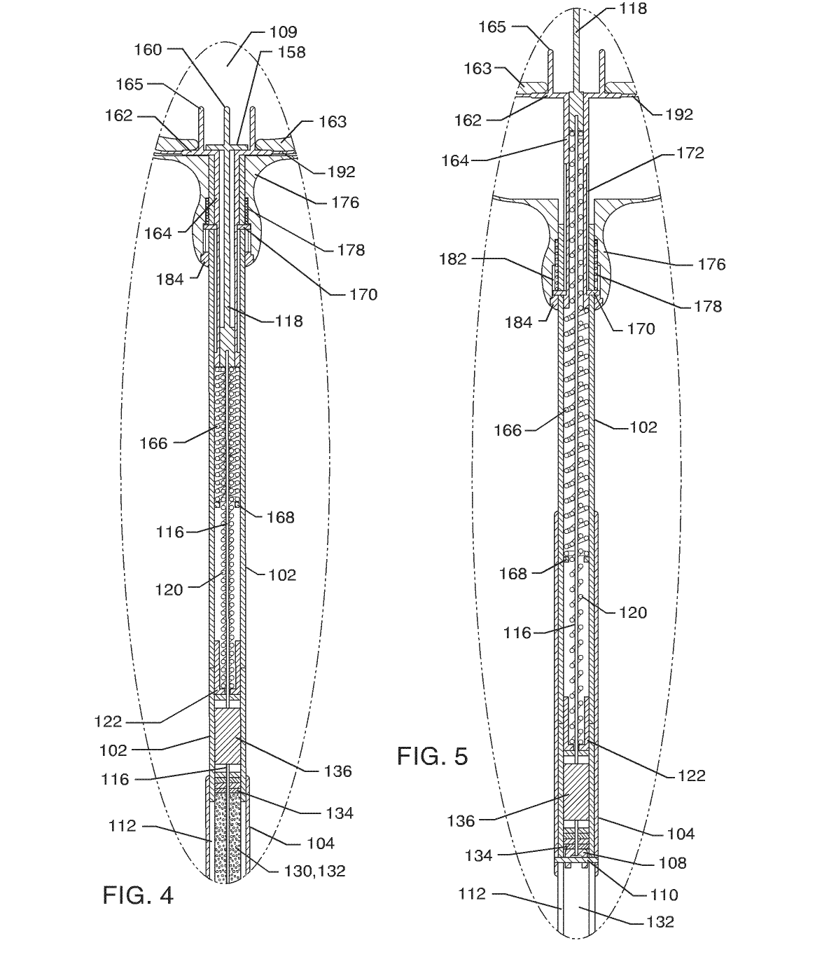

A drive line 116 is connected at the lower end thereof to the piston 108, and at the upper end thereof to a drive shaft 118 that is slidably disposed within the stem 102. As illustrated in FIG. 3, a helically coiled resilient drive shaft spring 120 is positioned in a somewhat compressed state within the stem 102 between the lower end of the drive shaft 118 and an annular drive shaft spring base 122 that is durably affixed within the stem 102 above the piston 108. The drive line 116 is thereby tensioned, and the drive shaft 118 and piston 108 are biased upwardly. That portion of the drive line 116 which passes through the drive shaft spring 120 can be substantially rigid to reduce distortion or buckling of the drive shaft spring 120. As illustrated in FIGS. 2 and 4, compression of the drive shaft spring 120 is greater when the flower 100 is in the closed state. The application of a compressive force to the drive shaft spring 120 by a downward manipulation of the piston 108 using the sleeve 104 puts energy into the drive shaft spring 120. This energy can be removed upon an actuating event to produce a desired motion of animation in the flower 100.

In one embodiment, the piston pin tracks 112 comprise two vertical slots through generally diametrically opposing sides of the stem 102 that are wide enough to clear the diameter of the piston pin 110. In addition to providing clearance for an attachment between the piston 108 and sleeve 104, the piston pin tracks 112 reduce or prevent rotation of the sleeve 104, and can limit the extent of the vertical motion thereof. As illustrated in FIG. 9, a piston pin lock slot 124 is extended in a circumferential direction from the lower end of each piston pin track 112 as a short track of similar width. The piston 108 can be temporarily locked into its lowest position by manually lowering and then rotating the sleeve 104 to move the piston pin 110 into the piston pin lock slots 124.

A chamber inlet 126 is an aperture in the stem 102 for inserting an impeding agent 130 therethrough and into a piston chamber 132. As illustrated in FIGS. 2 and 3, the piston chamber 132 is generally the space within the stem 102 through which the piston 108 can travel, the lower bound being the upper surface of the piston 108 at its lowest position, and the upper bound the lower surface of a retaining stop 134 that is durably affixed within the stem 102. The retaining stop 134 is a generally cylindrical elastic plug having a small axial aperture to allow the drive line 116 to pass slidably therethrough. The retaining stop 134 retains the impeding agent 130 within the piston chamber 132 and reduces the entry of liquid into the upper mechanisms. When the sleeve 104 is fully rotated such that the piston pin 110 is moved to the closed ends of the piston pin lock slots 124, a sleeve aperture 128 is aligned with the chamber inlet 126, as illustrated in FIG. 10. The impeding agent 130 can be manually placed into the piston chamber 132 in this configuration. In one embodiment, the sleeve aperture 128 is configured so that the piston pin tracks 112 are not exposed thereby at any position of the sleeve 104.

After placing the impeding agent 130 into the piston chamber 132, the piston pin 110 can be released from the piston pin lock slots 124 by manually rotating the sleeve 104 as illustrated in FIG. 11. In this position, the piston pin 110 is again aligned with the piston pin tracks 112, and the chamber inlet 126 and sleeve aperture 128 are out of alignment. Access to the piston chamber 132 is thereby closed and the impeding agent 130 is retained. The presence of the impeding agent 130 in the piston chamber 132 impedes upward motion of the piston 108, retaining the energy stored in the drive shaft spring 120 (and in other resilient springs as will be described more fully herein). Initially, compression by the piston 108 of the impeding agent 130 within the piston chamber 132 can result in a slight settling or packing of the impeding agent 130. This can cause a slight change in position of the piston 108, setting the piston pin 110 out of alignment with the piston pin lock slots 124, thereby hindering undesired rotation of the sleeve 104.

If, while attempting to manually lock the piston pin 110 into the piston pin lock slot 124 before placing the impeding agent 130 into the piston chamber 132, the user inadvertently releases the sleeve 104, this could result in the piston 108 and drive shaft 118 accelerating quickly through the stem 102. This could cause the quick and violent opening of the corolla 107, which is undesirable and could cause the ejection and loss of a surprise gift. Accordingly, in certain embodiments, a brake assembly 136 prevents or reduces the severity of such incidents. In such embodiments, the brake assembly 136 is secured in a fixed position within the stem 102 interposing the piston 108 and the drive shaft 118, as illustrated in FIG. 2 through FIG. 5. The brake assembly 136 applies a brake to slow or stop the motion of the through-traveling drive line 116 when tension on the drive line 116 is significantly reduced or lost. The brake assembly 136 works well with a drive line 116 that has threadlike flexibility.

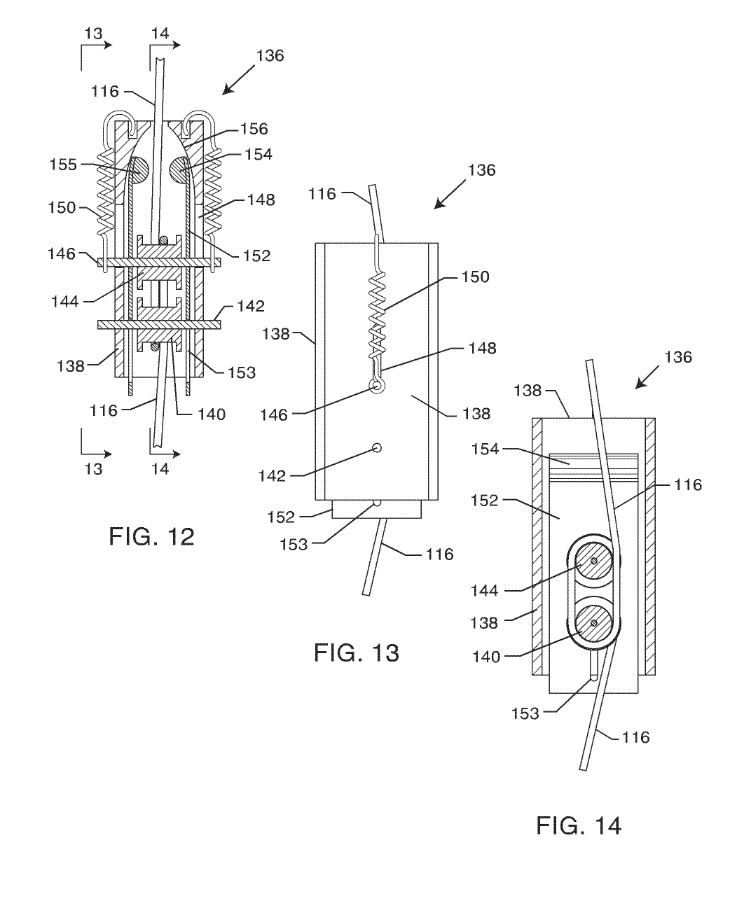

An example brake system is illustrated in FIG. 12 through FIG. 17. In particular, FIG. 12 through FIG. 14 illustrate the brake assembly 136 operating in a non-braking mode. The brake assembly 136 includes a brake housing 138, typically comprising a four-sided box structure. A lower pulley 140 is rotatably mounted or otherwise attached to a lower pulley axle 142, which is extended horizontally through the brake housing 138 in a substantially fixed relation thereto. An upper pulley 144 is rotatably mounted or otherwise attached to an upper pulley axle 146 which is positioned horizontally in vertically configured upper axle slots 148 formed in the brake housing 138. Brake springs 150 bias the upper pulley axle 146 upwardly. However, the tension of the drive line 116, which passes jointly over both the lower pulley 140 and upper pulley 144, normally overcomes the force of the brake springs 150 and draws the upper pulley axle 146 downwardly.

In the example embodiment illustrated in FIG. 12 through FIG. 14, a brake shoe 152 is configured as a resilient and typically flat rectangular mount which travels generally along a brake shoe guide 156, defined by an inner surface of the brake housing 138. The brake shoe 152 can include a resilient brake pad 154 attached along the upper side thereof facing the drive line 116. The upper pulley axle 146 protrudes through a hole of similar diameter in the brake shoe 152 and thereby defines the vertical position of the brake shoe 152. A vertical brake shoe slot 153 in the brake shoe 152 provides clearance for the lower pulley axle 142 to allow vertical motion of the brake shoe 152. The brake shoe guide 156 gradually curves inwardly at the upper end towards the drive line 116.

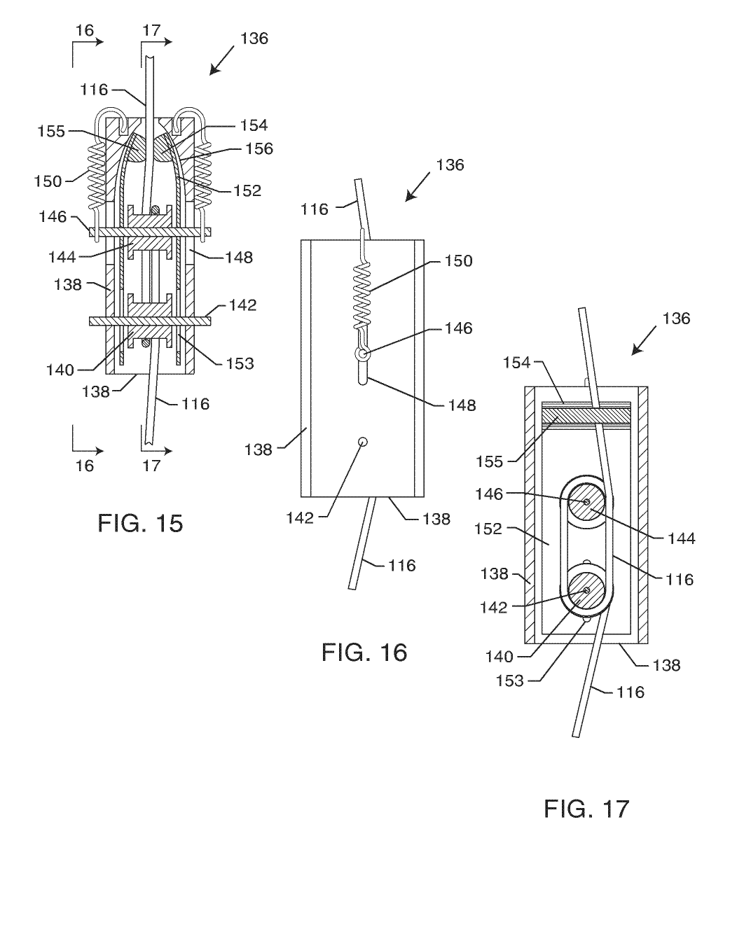

FIG. 15 through FIG. 17 illustrate the brake assembly 136 in a braking mode. When tension of the drive line 116 is significantly reduced or lost, the upper pulley axle 146 is pulled upwardly through the upper axle slots 148 by the bias of the brake springs 150. This upward motion of the upper pulley axle 146 draws the brake shoe 152 upwardly as well, and by the inwards curvature of the brake shoe guide 156, causes the brake shoe 152 to bow towards the drive line 116. The brake pad 154 comes into contact with and pinches the drive line 116, in one embodiment, against a second brake pad 155, thereby restoring some upward tension to that part of the drive line 116 above the braking point. The narrowing curvature of the brake shoe guide 156 compounds the gripping force of the brake pad 154 and increases the tension of the drive line 116 between the brake pad 154 and drive shaft 118. This safely retards or stops the motion of the drive line 116, and consequently other members of the flower 100. The flower 100 can be reset simply by manually pulling the sleeve 104 downwardly to restore tension to the drive line 116 at the end attached to the piston 108, thereby drawing downwardly the upper pulley axle 146, and with it, the brake shoe 152.

FIG. 2 illustrates the flower 100 in the closed state. The piston 108 is constrained from an upwardly advancing motion by the impeding agent 130 in the piston chamber 132. Consequently, the drive shaft 118 is held at a lower position within the stem 102 and the corolla 107 is closed. The dissolution of the impeding agent 130 allows the piston 108 to gradually and controllably ascend at a rate commensurate to the rate of dissolution of the impeding agent 130, causing the flower 100 to transition to the opened state. As illustrated in FIG. 3, following the substantial or complete dissolution of the impeding agent 130, the piston 108 is stopped at or near the retaining stop 134, the piston pin 110 is stopped at or near the upper end of the piston pin tracks 112, the corolla 107 is open, and the drive shaft 118 is extended upwardly.

In one embodiment, the dissolution of the impeding agent 130 is accomplished by manually placing the stem 102 into a container of a select liquid, such as water, the depth thereof sufficient to immerse at least a portion of the piston chamber 132. Various types and forms of spaces and apertures in and between the component parts related to the piston chamber 132 provide fluid passageways for the select liquid to enter into the piston chamber 132 to dissolve the impeding agent 130 and thereby diminish the solid volume of the impeding agent 130. In one embodiment, the select liquid can infiltrate through a space or gap defined by the fit of the sleeve 104 over the stem 102, flow to and through the apertures in the piston chamber 132 that are normally covered by the sleeve 104, specifically, the piston pin tracks 112 and chamber inlet 126, infuse through the impeding agent 130 in the piston chamber 132, and then, by fluidic currents generated by regional differences in the concentration of the forming solution or otherwise, carry out the impeding agent 130 in solution, removing it from the piston chamber 132 and from within the stem 102. The sizes of the various apertures, such as the gap between the sleeve 104 and stem 102, are set by design to substantially retain the solid particles, granules, pellets or unit of the impeding agent 130, defining a typical minimum size thereof that can be conveniently used, yet after immersion, allow circulation of the select liquid to and through the piston chamber 132.

As the sleeve 104 advances upwardly with the piston 108, the piston pin tracks 112 and chamber inlet 126 become exposed, allowing the select liquid to more readily circulate through the stem 102 and infiltrate the impeding agent 130 through the space or gap defined by the fit of the piston 108 within the stem 102. To accommodate a very lax fit of the piston 108 within the stem 102, the bottom end of the stem 102 can be closed to prevent the impeding agent 130 from escaping out of the stem 102 before immersion of the stem 102 into the select liquid. Moreover, the stem 102, sleeve 104 and piston 108 alternatively or optionally can comprise porous materials or construction, mesh screen materials or inserts, and/or additional apertures specifically designed to admit the select liquid into the piston chamber 132 while substantially retaining the solid impeding agent 130 therein.

The rate of dissolution of the impeding agent 130 by the select liquid is controllable by factors including the nature, form and composition of the impeding agent 130, the nature and temperature of the select liquid, agitation of the select liquid, the size of the particles, granules, pellets or unit of the impeding agent 130, and the starting concentration of the impeding agent 130 or other impurities in solution in the select liquid. Additionally, the rate of dissolution of the impeding agent 130 by the flower 100 can be controlled by the fit of the sleeve 104 over the stem 102, the porosity of the materials used to construct the sleeve 104, stem 102 and piston 108, and the fit of the piston 108 within the stem 102. Thus, the time required for the flower 100 to transition from the closed state to the opened state can be controlled to range from less than a minute to many days. In one embodiment, the transition period can be between about 3 seconds and about 45 minutes. However, in other embodiments, the transition can be less than 3 seconds or greater than 45 minutes. In another embodiment the transition period is controlled to be between 3 seconds and 10 seconds. In another embodiment, the transition period is controlled to be between 1 minute and 2 minutes. In yet another embodiment, the transition period is controlled to be between 30 minutes and 45 minutes. Removing the flower 100 from the select liquid generally causes a substantial suspension of animation activity. Restoring the flower 100 to the select liquid generally causes a resumption of animation activity.

As the select liquid circulates through the piston chamber 132 and the impeding agent 130 dissolves and diminishes in effective size, the piston 108 is gradually pulled upwardly by the drive line 116 due to the force of the drive shaft spring 120 upon the drive shaft 118 (and by other resilient springs as will be described more fully herein). The drive shaft 118 optionally includes a presentation platform 158 attached at the upper end thereof, as illustrated in FIG. 2 through FIG. 8. A surprise object or gift (not illustrated) can be associated with the flower 100 by being installed on the presentation platform 158, and fully or partially concealed within a cavity 109 defined by the closed corolla 107, and revealed when the corolla 107 is opened and/or when raised by the presentation platform 158 above the corolla 107. The presentation platform 158 optionally includes a load coupling pin 160, or other structure to durably or removably fasten the surprise gift to the presentation platform 158.

The load coupling pin 160, typically an upwardly projected generally cylindrical pin, can also be used to change the state of a switch, thereby activating a feature in the surprise gift when the surprise gift is manually removed from the raised presentation platform 158. For example, in one embodiment disengaging the surprise gift from the load coupling pin 160 allows electrical contacts within the surprise gift to close, typically as illustrated in several of the embodiments subsequently described herein, thereby energizing an electronic circuit to provide illumination, sound and/or motion in the surprise gift. In one embodiment, disengaging the surprise gift from the load coupling pin 160 can operate a mechanical actuator within the surprise gift, thereby actuating a mechanism to, for example, produce a motion of the surprise gift, or can operate a hydraulic valve to, for example, release a fragrant liquid. For example, disengaging the surprise gift from the load coupling pin 160 can unplug or tear open a small packet to expose a fragrant substance, or can perform many other electrical and/or mechanical actions.

Furthermore, one or more load control pins 165, typically of a shape similar to the load coupling pin 160, can be attached to and projected upwardly from the upper surface of a petal hinge stage 162 or other nearby member. In one embodiment, the load control pins 165 are automatically withdrawn from the surprise gift as the presentation platform 158 ascends relative to the petal hinge stage 162 and thereby can similarly activate other electrical and/or mechanical features of the surprise gift, for example, before the corolla 107 fully opens. When two or more load control pins 165 are employed, the lengths thereof can differ, enabling a sequential actuation of the features.

The state of a switch can be changed without the use of the load coupling pin 160 or the load control pin 165. Other contact and actuator arrangements can be employed to accomplish some of the functions associated herein to the load coupling pin 160 or the load control pin 165. For example, the switch can comprise an actuating arm that senses the proximity of the surprise gift to the presentation platform 158 independently of the load coupling pin 160. Dissociating the surprise gift from the presentation platform 158 changes the state of such a switch. Similarly, other contact and actuator arrangements can accomplish the functions of one or more load control pins 165 in a different manner. For example, a switch that senses the proximity of the surprise gift or presentation platform 158 to the petal hinge stage 162 can comprise a member that does not resemble the load control pin 165, but that accomplishes the same functions. A great variety of switch types can be adapted for use with the flower 100.

In an example embodiment, the surprise gift is coupled to the presentation platform 158 using a removable attachment mechanism specially configured for the particular surprise gift being included. For example, in one embodiment the presentation platform 158 comprises a durably or removably attached intermediate adapter or holder. For instance, if the surprise gift is an item of jewelry that cannot be readily coupled to the load coupling pin 160, then the presentation platform 158 can instead comprise a durably or removably attached gift box to hold the item of jewelry.

The flower 100 can be accompanied by an unattached optional accessory set comprising a plurality of discrete adapters and holders (not illustrated) for use with the presentation platform 158, each one comprising a common connector at its lower side that is configured to be removably coupled to a standardized connector at the top of the presentation platform 158, such as the load coupling pin 160 shown, and configured at its upper side to removably attach or house a specific type of surprise gift, the adapter or holder specifically suited to a specific type or size of surprise gift.

One or more of the electronic and mechanical features previously described herein as switchable by the load coupling pin 160 and load control pins 165 can be fully incorporated into one or more of, or partially incorporated into and span in combination, the presentation platform 158, the durably or removably attached adapters or holders, and the surprise gift. The adapters and holders can present the surprise gift in several ways, such as fully exposed, under a removable covering, or enclosed in an openable container.

Referring now to FIG. 4 through FIG. 8, an inner stem 164 is slidably disposed in a telescoping manner within the upper end of the stem 102 and biased upwardly by a helically coiled resilient inner stem spring 166. The inner stem spring 166 is positioned within the stem 102 in a compressed state between an inner stem lower end 174 and an inner stem spring base 168. The inner stem spring base 168 can be a rigid annular support durably affixed within the stem 102 below the inner stem 164. Typically, the inner stem spring 166 is positioned concentric to the drive shaft spring 120 and is supported from buckling or interference with the drive shaft spring 120 by the wall of the stem 102. In one embodiment, to further reduce interference between the drive shaft spring 120 and inner stem spring 166 in case of buckling or bending of the drive shaft spring 120, the coils of each can be wound in opposite directions.

In one embodiment, a generally cylindrically shaped growth limit pin 170 is affixed within the wall of the stem 102, protruding radially from both the inner and outer surfaces of the wall of the stem 102. The inner protruding tip of the growth limit pin 170 resides in an inner stem pin groove 172 formed in the outer wall of the inner stem 164. The inner stem pin groove 172 is a linear vertical track partially through the wall of the inner stem 164 having a width and depth sufficient to clear the inner protruding portion of the growth limit pin 170. The length of the inner stem pin groove 172 defines the vertical travel of the inner stem 164.

As shown in FIG. 1, the calyx 186, by the receptacle 176 thereof, slidably overlaps the upper end of the stem 102 in a telescoping manner. Referring again to FIG. 4 through FIG. 8, a helically coiled resilient calyx spring 178 is positioned in a compressed state within a recess within the receptacle 176 between a calyx spring ledge 180 and the outer protruding barrel of the growth limit pin 170, so as to bias the calyx 186 upwardly. The outer protruding tip of the growth limit pin 170 resides in a calyx pin groove 182 formed in the inner wall of the receptacle 176 at the recess of the calyx spring 178. The calyx pin groove 182 is a linear vertical track partially through the wall of the receptacle 176 having a width and depth sufficient to clear the outer protruding portion of the growth limit pin 170. The length of the calyx pin groove 182 can define the vertical travel of the calyx 186. A receptacle plug 184 durably affixed at the lower end of receptacle 176 defines the lower end of the calyx pin groove 182 and simplifies manufacturing assembly.

The petal hinge stage 162 is attached to the upper end of the inner stem 164. The petal hinge stage 162 is typically a flange, projected outwardly from the inner stem 164 above the stem 102, and functions as a common attachment basis of the corolla 107 and the ancillary mounting component parts thereof, whereby the corolla 107 can be attached to the inner stem 164.

When the flower 100 is in the closed state, the presentation platform 158 overlies and blocks ascent of the inner stem 164 at the petal hinge stage 162, which in turn similarly overlies and blocks ascent of the calyx 186 at the receptacle 176. The initial lifting force on the piston 108 as transmitted through the drive line 116 is the sum of the forces of the drive shaft spring 120, inner stem spring 166, and calyx spring 178. As the flower 100 transitions to the opened state, the calyx 186 and the inner stem 164 with the attached corolla 107 each ascend as allowed by the upwardly advancing presentation platform 158, but stop short as each is individually limited by the growth limit pin 170.

In one example embodiment, the ascent of the calyx 186 stops first. But because the inner stem pin groove 172 is longer than the calyx pin groove 182, the inner stem 164 and attached corolla 107 continue to ascend. After the corolla 107 has opened, the ascent of the inner stem 164 and attached corolla 107 also stops. However, the presentation platform 158 continues to ascend, halting when the piston 108 meets the retaining stop 134 or when the piston pin 110 meets the upper end of the piston tracks 112, actions that optionally coincide. The ascent of the calyx 186 as it slides upwardly along the stem 102 provides a realistic simulation of natural flower growth, as illustrated by the difference in the extension of the calyx 186 relative to the stem 102 between FIG. 2 and FIG. 3, or between FIG. 4 and FIG. 5.

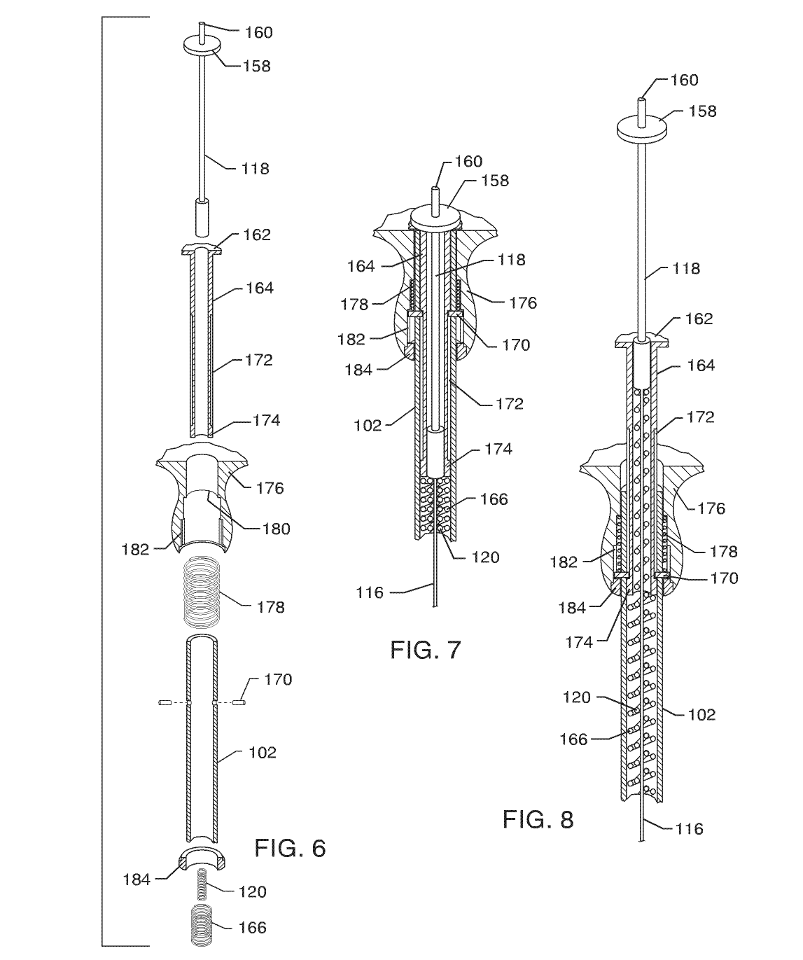

In alternative embodiments, the inner stem pin groove 172 and calyx pin groove 182 can each be fashioned as a non-linear helical track that resembles a screw thread, rather than the linear vertical track as illustrated in FIG. 6. A slight helical twist in the direction of the inner stem pin groove 172 and calyx pin groove 182 can impart a subtle rotation to the inner stem 164 and calyx 186 that concurs with the ascent thereof. The presented effect is a gentle rotation in the perianth 106 as the flower 100 transitions to the opened state. Alternatively, instead of the pin and groove system described, other types of mating screw threads which impart rotation by linear drive can be used to provide a similar result.

Referring again to FIG. 2 through FIG. 5, petal hinges 192 are a plurality of generally oblong resilient flat springs attached to and projected outwardly radially, typically as spokes, from the petal hinge stage 162. The petal hinges 192 are normally flat and straight, but by their resilience, can be bent into an arcuate shape when drawn down by the petal hinge stage 162 into the calyx 186, as illustrated in FIG. 2. The petal hinges 192 extend outwardly to open when positioned generally above the calyx 186, as illustrated in FIG. 3. The petal hinges 192 can be tapered, such that the width or thickness is greater towards the petal hinge stage 162 and lesser towards the outer ends thereof, to allow them to bend more readily into the shape of the calyx 186 when drawn therein by the descending inner stem 164.

As illustrated in FIG. 2 and FIG. 3, petal feet 194 are attachment sites at the outer ends of the petal hinges 192. The petal feet 194 support the attachment of typically one inner petal 196 on the upper or inner surface thereof, and typically one outer petal 198 on the lower or outer surface thereof. In other embodiments, the petal feet 194 each support more or fewer petals. The petal feet 194 can be vertically flared or tapered to set the inner petals 196 and outer petals 198 at differing attachment angles. When the flower 100 is in the closed state the inner petals 196 define the cavity 109 above the presentation platform 158 configured to enclose and conceal the surprise gift. The inner petals 196 can be more rigid and can more fully close at their upper ends than the outer petals 198, to reduce the likelihood that a recipient of the flower 100 might inadvertently discover the contents of the cavity 109 while manipulating the outer petals 198.

The internal base of the corolla 107, including the petal hinge stage 162 and petal hinges 192, is optionally covered by a decorative filler 163, as illustrated in FIG. 2 and FIG. 3, to improve the aesthetics of the opened corolla 107. The decorative filler 163 can be a flexible covering material, in the shape of a flat washer, which includes features that resemble parts of a natural flower.

Referring again to FIG. 1 through FIG. 3, the upper perimeter of the calyx 186 optionally includes an encircling ring of a typically alternating arrangement of thick sepals 188 and thin sepals 190 projected upwardly therefrom. Typically, each assembly of an outer petal 198 and petal hinge 192 has an associated thick sepal 188 or thin sepal 190 in radial alignment therewith which partially covers the outer petal 198 when the flower 100 is in the closed state. The thick sepals 188 and thin sepals 190 are resilient and flexible, bowing outwardly when overcome by the force of the straightening petal hinges 192 above them as the flower 100 transitions to the opened state, and recovering the upwardly projected form thereof when the force thereon is removed as the flower 100 transitions to the closed state.

In one embodiment, the thin sepals 190 can have a greater flexibility and a lesser resilient restoring force than the thick sepals 188. The terms “thick” and “thin” used in connection with the labels “thick sepals” and “thin sepals” are not limiting and can describe any difference or no difference in the physical properties of the thick sepals 188 and thin sepals 190. In one embodiment, the terms are intended to convey a difference in the flexibility and/or resilience between the thick sepals 188 and thin sepals 190. This difference in flexibility and/or resilience can be achieved by a variation, irregularity, asymmetry and/or differentiation of a physical property, including at least one of flexibility, resilience, size, shape, structure, material composition, a connective feature, attachment position and/or attachment location.

Due to the difference in the flexibility and/or resilience between the thick sepals 188 and thin sepals 190, different petal hinges 192 are forced out of and into the arcuate shape during the opening and closing of the corolla 107 at starting times, rates and/or to extents that vary slightly from other petal hinges 192. As the closed corolla 107 ascends to open, the thin sepals 190 bow outwardly under the adjacent straightening petal hinges 192 more readily than do the thick sepals 188, to provide a pleasing variety in the starting times, rates and/or extents of opening of the outer petals 198, enhancing the presentation thereof. As the opened corolla 107 is retracted back into the closed state, the thin sepals 190 restoringly press inwardly against the adjacent lowering petal hinges 192 with less pressure than do the thick sepals 188, thereby closing the outer petals 198 at differing starting times, rates and/or to different extents. In one embodiment, the outer petals 198 are closed without edge interference in an ordered overlap.

In one embodiment, alternating outer petals 198 overlap neighboring outer petals 198 of the closed corolla 107 in an orderly fashion, as illustrated in FIG. 1. This permits the use of large overlapping outer petals 198 for additional realism and adds to the pleasing aesthetics when the flower is fully opened, as illustrated in FIG. 3. Of course, it will be appreciated by those of ordinary skill in the art that, instead of, or in addition to, the previously described petal hinges 192 of a uniform flexibility and resilience being forced into and out of arcuate shapes at differing starting times, rates and/or extents by thick sepals 188 and thin sepals 190 of varying flexibility and/or resilience, similar ends can be achieved by petal hinges 192 that differ in flexibility and/or resilience being forced into and out of arcuate shapes at differing starting times, rates and/or extents by thick sepals 188 and thin sepals 190 of a uniform flexibility and resilience.

Variations in the opening and closing starting times, rates and/or extents of opening and closing of the inner petals 196 and outer petals 198 can be achieved by a variation, irregularity, asymmetry and/or differentiation of a physical property, including at least one of flexibility, resilience, size, shape, structure, material composition, a connective feature, attachment position and/or attachment location of the calyx 186, thick sepals 188 and thin sepals 190, inner petals 196, outer petals 198, petal hinges 192, petal hinge stage 162 and/or other members connected thereto.

The flower 100 can be reused. At the conclusion of the animation activities of the flower 100 and optionally following the removal of the surprise gift from the presentation platform 158, the flower 100 has finished an operation cycle. A new surprise gift can be chosen for inclusion in the flower 100. The new surprise gift can be manually coupled or otherwise attached to the extended presentation platform 158 of the opened corolla 107, and the sleeve 104 can be manually lowered to retract the presentation platform 158 and close the corolla 107 to conceal the surprise gift. Alternatively, the surprise gift can be reused by recoupling it to the presentation platform 158. The sleeve 104 can then be manually locked, the piston chamber 132 refilled, and the sleeve 104 unlocked. The flower 100 is then ready for another presentation.

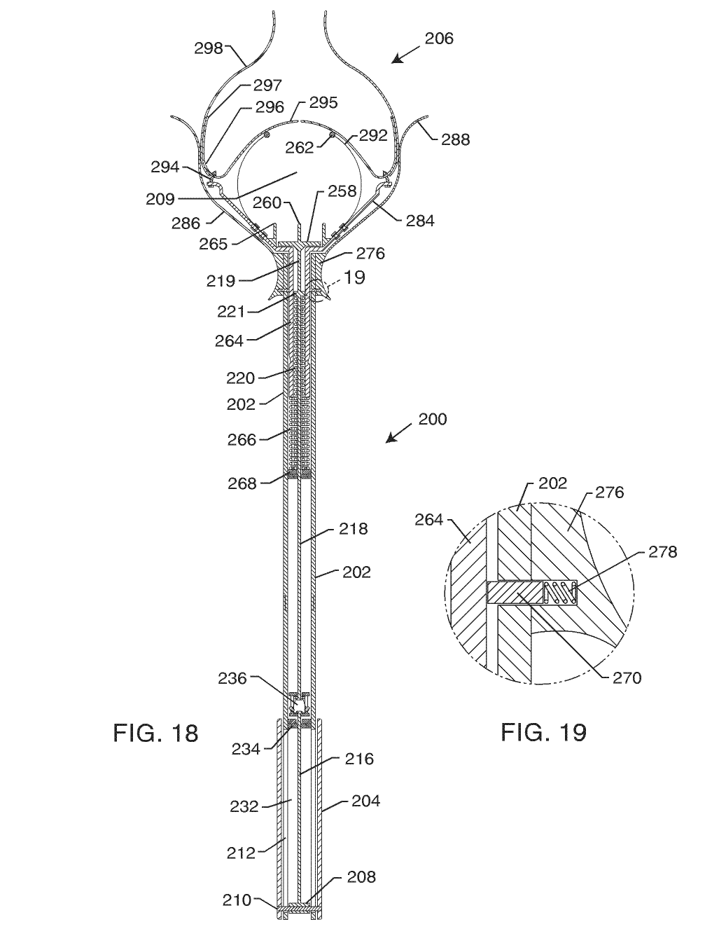

Alternative embodiments of an animated flower are illustrated in FIG. 18 through FIG. 25. In such embodiments, flower 200 includes a stem 202, sleeve 204, piston 208, piston pin 210 and piston pin tracks 212. Certain features of the flower 200 are similar in form and function to the corresponding features of the previously-described flower 100. For example, the sleeve 204 is slidable and rotatable with respect to the stem 202, and the piston 208 is slidably disposed within the stem 202 and is biased upwardly. The piston 208 is connected to the sleeve 204 via piston pin 210, which is situated horizontally therethrough. Piston pin tracks 212 configured through the stem 202 provide clearance for the piston pin 210.

The piston chamber 232 and retaining stop 234 of the flower 200 are similar in form and function to the corresponding features of the previously-described flower 100. As such, the piston 208 can be locked into a lower position by manually twisting the sleeve 204 such that the piston pin 210 is moved into piston pin lock slots (not illustrated) in the stem 202, which extend laterally from the lower ends of the piston pin tracks 212. The sleeve 204 and stem 202 can each include apertures (similar to the apertures 126 and 128 in the embodiment of FIG. 9) which are aligned, when the piston 208 is locked, to provide access to the piston chamber 232 within the stem 202. A retaining stop 234 defines the upper bound of the piston chamber 232. An impeding agent, such as the impeding agent 130 in the embodiment of FIG. 10, can be manually placed into the piston chamber 232 through the aligned apertures in the sleeve 204 and stem 202.

When the flower 200, into which an impeding agent had been previously placed, is placed into a container of a select liquid, the select liquid enters the piston chamber 232 through various types and forms of spaces and apertures in and between the component parts related to the piston chamber 232, and dissolves and reduces the solid volume of the impeding agent. The piston 208 gradually ascends as the effective size of the impeding agent diminishes by dissolution.

The flower 200 illustrated in FIG. 18 through FIG. 25 shows an alternative to the fixed-position brake assembly 136 and the drive line 116 of flower 100. Alternatively, a slidable brake assembly 236 can be interposingly connected to a two-piece drive line comprising a lower drive line 216 and an upper drive line 218. Unlike the brake assembly 136 of the flower 100, which has a fixed position within the stem 102 whereby it acts on the through-passing drive line 116, the brake assembly 236 is pulled through the stem 202 by the lower drive line 216 or upper drive line 218 and acts on a fixed brake receiving surface comprising the inner wall of the stem 202. The lower drive line 216 is attached to and is projected upwardly from the piston 208, and the upper drive line 218 is attached to and projected downwardly from a drive shaft 219 which, in turn, is attached to and projected downwardly from a presentation platform 258. The brake assembly 236 accommodates the use of a rigid lower drive line 216 and/or upper drive line 218, and uses a length of the stem 202 approximately equal to the extent of travel of the piston 208.

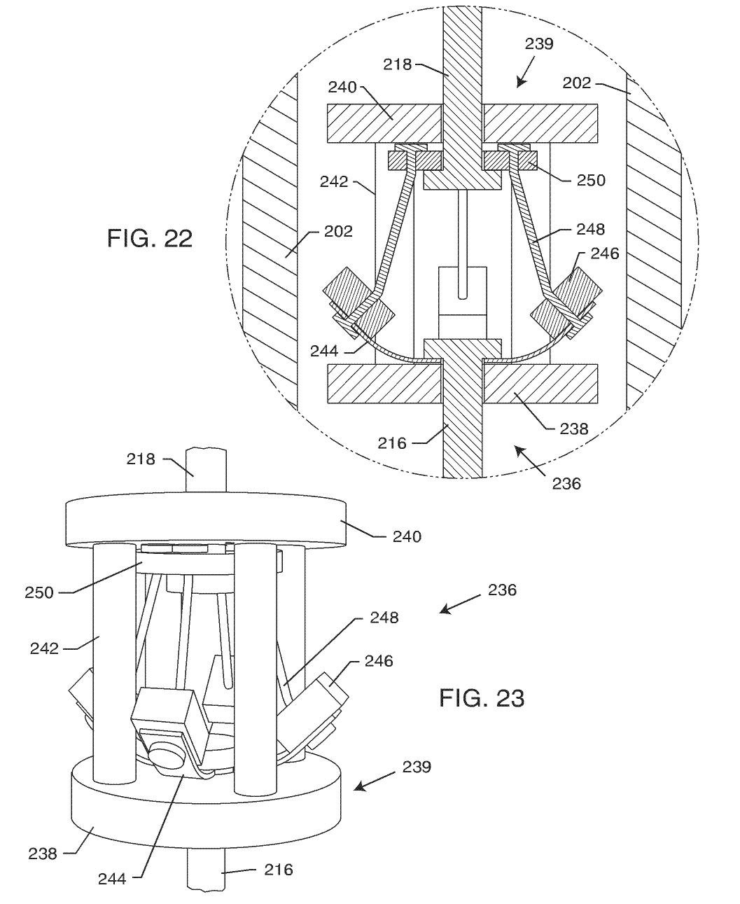

Referring now to FIG. 22 through FIG. 25, the brake assembly 236 functions by converting the vertical elongation of a resilient braking member to a horizontal expansion when tension is lost. More particularly, a loss of tension between the lower drive line 216 and upper drive line 218 relaxes the vertical deflection of a brake spring 244, restoring the at-rest horizontal extension thereof, and thereby moving an attached brake pad 246 into braking contact with the brake receiving surface. In the example brake assembly 236, normal operating tension bows the brake spring 244 by upwardly pulling the outer end thereof, holding the attached brake pad 246 away from the brake receiving surface. The brake receiving surface can be provided by the untreated inner surface of the wall of the stem 202. Alternatively, to enhance the grip of the brake pads 246, the brake receiving surface is mechanically treated and/or includes a coating material and/or an additional member attached to the inner surface of the wall of the stem 202.

The brake assembly 236 optionally includes a housing to limit brake elongation. The brake elongation limit housing 239 provides an upper limit to the degree of separation of the lower drive line 216 from the upper drive line 218, and thereby, the maximum tension applicable to the brake spring 244, protecting it from damage. The brake elongation limit housing 239 typically comprises a lower brake plate 238 and upper brake plate 240, each having a generally cylindrical shape and an axial aperture therethrough to loosely receive the lower drive line 216 and upper drive line 218, respectively. The brake elongation limit housing 239 also includes a plurality of brake plate posts 242 affixed between the lower brake plate 238 and upper brake plate 240 generally around the perimeters thereof. The ends of the lower drive line 216 and upper drive line 218 are held captive within the brake elongation limit housing 239, retained therein typically by flared or otherwise enlarged tips.

In one embodiment, the brake spring 244 comprises a normally flat leaf spring having a central aperture therethrough to loosely receive the lower drive line 216, and typically includes a plurality of radial spokes. Each spoke of the brake spring 244 is extended through a space between the brake plate posts 242 and has at least one brake pad 246 attached to the outer end, for example at the upper surface thereof. In one embodiment, the brake pads 246 are extended slightly beyond the outer tip of each spoke of the brake spring 244. The distance from the center of the brake spring 244 to the outer end of each spoke, when the brake spring 244 is at rest and flat, is slightly less than the inner radius of the brake receiving surface. The distance from the center of the brake spring 244 to the outer surface of each attached brake pad 246, when the brake spring 244 is at rest and flat, is slightly greater than the inner radius of the brake receiving surface.

The brake spring 244 is optionally sandwiched loosely between the flared end of the lower drive line 216 and the lower brake plate 238, or can otherwise be attached at its center to the upper side of the lower brake plate 238 to prevent a downward bowing of the spokes of the brake spring 244. Furthermore, the outer end of each spoke of the brake spring 244 optionally has an aperture aligned with a similar aperture through generally the center of the attached brake pad 246.

A brake cable bracket 250 is a typically flat support configured to fit loosely within the brake plate posts 242 of the brake elongation limit housing 239. The brake cable bracket 250 includes a central aperture therethrough to loosely receive the upper drive line 218, and typically a smaller peripheral aperture for each brake pad 246 employed. The brake cable bracket 250 can be sandwiched loosely between the flared end of the upper drive line 218 and the upper brake plate 240, or can otherwise be attached to the lower end of the upper drive line 218.

In one embodiment, the brake pads 246 have an associated brake cable 248. One end of each brake cable 248 is attached at one of the peripheral apertures of the brake cable bracket 250. The other end of each brake cable 248 is extended through the aperture of the nearest brake pad 246 and is attached at the corresponding aperture in the brake spring 244. The attachment of the brake cable 248 can be secured typically by flared or otherwise enlarged ends.

When, within the brake elongation limit housing 239, the distance between the ends of the lower drive line 216 and upper drive line 218 is at its maximum, the brake cables 248 are configured to pull the spokes of the brake spring 244 upwardly into an arcuate shape such that the brake pads 246 are slightly removed from the brake receiving surface. The force required to bow the brake spring 244 in this manner is less than the force presented by the tension inducing resilient members as they are configured within the flower 200, which resilient members include a drive shaft spring 220. The length of the brake cables 248 is sufficient to allow the brake spring 244 to straighten out or open to its normally flat shape and apply the brake pads 246 to the brake receiving surface when the tension between the lower drive line 216 and upper drive line 218 is significantly reduced or lost.

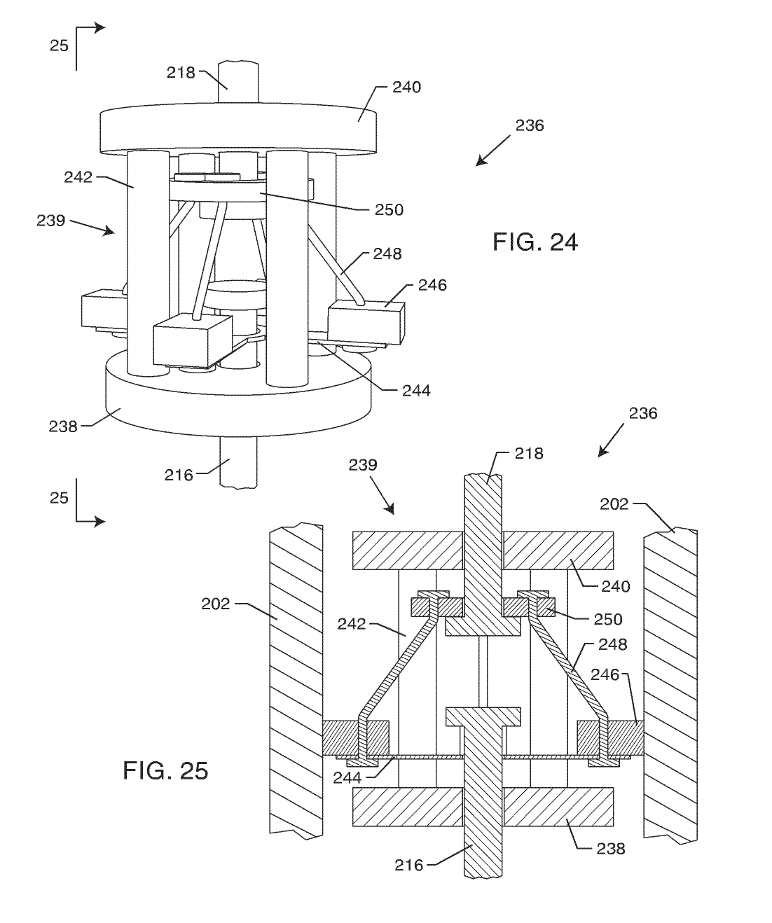

The conditions that characterize normal tension between the lower drive line 216 and upper drive line 218 and the circumstances that cause the reduction or loss of that tension are similar to those previously stated in the description of the flower 100. FIG. 22 and FIG. 23 illustrate the brake assembly 236 operating in a normal non-braking mode. The tension between the lower drive line 216 and upper drive line 218 holds the brake spring 244 in a bowed shape. FIG. 24 and FIG. 25 illustrate the brake assembly 236 operating in a braking mode. When the tension between the lower drive line 216 and upper drive line 218 is significantly reduced or lost, the brake spring 244 returns to its normally flat form. Therewith, the brake pads 246 are pivoted outwardly and downwardly and make contact with the brake receiving surface. Upwardly advancing motion of the upper drive line 218, which is connected to the brake pads 246 by the brake cable bracket 250 and brake cables 248, is thereby substantially suppressed. Tension between the lower drive line 216 and upper drive line 218 can be reestablished by a manual downward retraction of the sleeve 204. The brake spring 244 is thereupon pulled again into a bowed shape and the brake pads 246 removed from contact with the brake receiving surface.

Referring again to FIG. 18 through FIG. 21, at their lower ends, the drive shaft spring 220 and an inner stem spring 266 each engage a spring base 268 that is durably affixed within the stem 202. At the upper ends thereof, the drive shaft spring 220 engages a node 221 at the lower end of the drive shaft 219, and the inner stem spring 266 engages the lower end of an inner stem 264. In an example embodiment, the drive shaft spring 220 and inner stem spring 266 are each helically coiled resilient compression springs, one positioned concentric to the other. In such an embodiment, the node 221 at the lower end of the drive shaft 219 is a small protuberance which defines the connection between the upper drive line 218 and drive shaft 219, and by engaging the drive shaft spring 220, minimizes the appearance of the drive shaft spring 220 below the presentation platform 258. In an example embodiment, the upper drive line 218 and drive shaft 219 are sufficiently rigid to sustain the presentation platform 258 when extended.

A perianth 206 comprises a calyx 286, which further comprises a receptacle 276 at its lower end. The receptacle 276 is durably affixed to the outer surface of the upper end of the stem 202. As illustrated in FIG. 19, a generally cylindrical inner stem limit pin 270 is slidably disposed in a socket comprising a radial aperture through the stem 202 and an aligned pocket in the inner wall of the receptacle 276. The inner stem limit pin 270 is biased inwardly towards the inner stem 264 by a limit pin spring 278. An inner stem pin groove 282 generally surrounds the inner stem 264 with a groove having a substantially chamfered upper edge. In the closed flower 200, the inner stem pin groove 282 is situated significantly below the inner stem limit pin 270.

As the flower 200 transitions to the opened state, the inner stem 264 ascends in a telescoping manner from within the stem 202 until, as illustrated in FIG. 21, the inner stem pin groove 282 comes into alignment with and is engaged by the inner stem limit pin 270. This halts further ascent of the inner stem 264 while other flower animation continues, including the ascent of the presentation platform 258. The chamfer in the upper edge of the inner stem pin groove 282 allows the inner stem limit pin 270 to exit the inner stem pin groove 282 during downward retraction of the inner stem 264. The circumferential direction of the inner stem pin groove 282 allows the inner stem 264 and attached component parts to be manually rotated within the stem 202 and calyx 286 without damaging the flower 200.

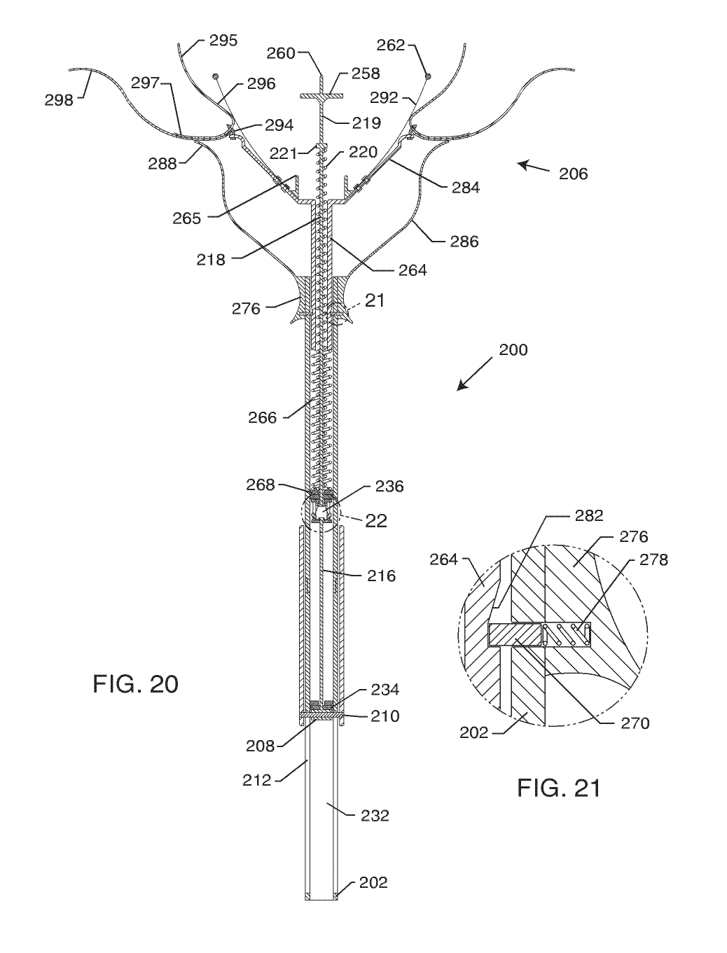

Referring still to FIG. 18 and FIG. 20, a petal hinge stage 284, which in an example embodiment has a generally truncated cone or cup shape, is disposed within the calyx 286 and attached to the upper end of the inner stem 264. The petal hinge stage 284 is an attachment basis of a corolla comprising petals 298, whereby the corolla can be attached to the inner stem 264. The upper perimeter of the petal hinge stage 284 comprises a generally flange-shaped rim crowned by a plurality of petal supports 296. The petal supports 296 can optionally include an inner blade 295 and an outer blade 297, which in the closed flower 200 are typically projected generally inwardly and upwardly, respectively.

The petal supports 296 can be connected at a fold between the blades 295 and 297 to the petal hinge stage 284 by flexible petal hinges 294. In one embodiment, the petal hinges 294 generally resemble a standoff rivet and are attached through apertures in the petal supports 296 and the rim of the petal hinge stage 284. In an example embodiment, each petal support 296 is attached by two or more petal hinges 294, to minimize on-axis rotation of the petal support 296, as can occur with the use of just one petal hinge 294. Alternatives to the petal hinges 294 as flexible standoff rivets include petal hinges 294 as flexible adhesive beads, pads and tape members that do not require apertures for installation, or rigid integral tabs projected upwardly from the rim of the petal hinge stage 284, each comprising a resilient barb in the upper tip thereof, the tab protruding loosely through apertures in the petal supports 296 and made irremovable by a snap fit of the barb through the aperture.

In an example embodiment, each petal support 296 has one corresponding petal spring 292, which is typically a normally flat and narrow leaf spring, attached to the petal hinge stage 284 by rivets or otherwise, and biased to push outwardly against the inner blade 295 of the petal support 296. In such embodiments, each petal spring 292 can have attached at its upper end a generally soft or smooth globose anther 262 configured to protect the petal supports 296 from wear and to provide a safe termination. Additionally, the petal springs 292, petal hinge stage 284 and other parts of the perianth 206, can be decoratively coated or covered for aesthetic purposes.

The petals 298 are typically attached to the outer blades 297 of the petal supports 296. The somewhat rigid inner blades 295 of the petal supports 296 can be configured as inner petals of the corolla and define a cavity 209 in the closed corolla which can enclose and conceal a surprise gift (not illustrated). A load coupling pin 260 provides a way to removably couple the surprise gift or a holder thereof (not illustrated) to the presentation platform 258 and, upon disengagement of the surprise gift from the presentation platform 258, activate an electrical or mechanical feature internally configured within the surprise gift or the gift holder. Load control pins 265 are withdrawn from the surprise gift or the gift holder as the presentation platform 258 ascends beyond the petal hinge stage 284, and can similarly actuate other electrical or mechanical features within the surprise gift or the gift holder. The cavity 209, surprise gift, gift holder, electrical and mechanical features, presentation platform 258, load coupling pin 260, load control pins 265, petal hinge stage 284, inner blades 295, and petals 298 of the flower 200 are similar in form and function to the cavity 109, surprise gift, intermediate adapter or gift holder, electrical and mechanical features, presentation platform 158, load coupling pin 160, load control pins 165, petal hinge stage 162, inner petals 196, and outer petals 198, respectively, described more fully in the disclosure of the flower 100.

The gradual upward advance of the piston 208 during dissolution of the impeding agent in the select liquid enables the gradual ascent of the presentation platform 258, petal hinge stage 284, the corolla and other attached members. A calyx perimeter 288 is curved outwardly to provide a surface that allows the petal supports 296 to turn outwardly gradually by the force of the petal springs 292 and open the petals 298 as the petal supports 296 ascend above the calyx 286. The corolla is fully opened as the inner stem limit pin 270 engages the inner stem pin groove 282 to halt the ascent of the inner stem 264 and petal hinge stage 284, however the presentation platform 258 continues its ascent until the piston 208 meets the retaining stop 234 or the piston pin 210 meets the upper ends of the piston pin tracks 212.

In one embodiment, the calyx perimeter 288 is configured with an upwardly and/or outwardly undulating shape to provide variety in the starting times, rates and/or extents of the opening and closing of the petals 298, an orderly overlap in the closing petals 298, and/or other features as described more fully in the disclosure of the arrangement of thick sepals 188 and thin sepals 190 of the flower 100. Alternatively or additionally, to obtain similar results, the upper perimeter of the petal hinge stage 284 can be configured with an upwardly and/or inwardly undulating shape to provide variety in the positions of the petal hinges 294 and petal supports 296, and/or petal springs 292 with varying degrees of resiliency can be used, and/or the shape or other physical characteristics of the petal supports 296 and/or petals 298 can be varied.

Variations in the opening and closing starting times, rates and/or extents of opening and closing of the petals 298 can be achieved by a variation, irregularity, asymmetry and/or differentiation of a physical property, including at least one of flexibility, resilience, size, shape, structure, material composition, a connective feature, attachment position and/or attachment location of the calyx 286, petals 298, petal supports 296, petal springs 292, petal hinges 294, petal hinge stage 284 and/or other members connected thereto.

At the conclusion of the animation activities of the flower 200 and optionally following the removal of the surprise gift from the presentation platform 258, the flower 200 can be used again. A new surprise gift can be manually coupled or otherwise attached to the extended presentation platform 258 of the opened corolla, and the sleeve 204 can be manually lowered to retract the presentation platform 258 and close the corolla to conceal the surprise gift. Alternatively, the surprise gift can be reused by replacing it on the presentation platform 258. The sleeve 204 can then be manually locked, the piston chamber 232 refilled, and the sleeve 204 unlocked. The flower 200 is then ready for another presentation.

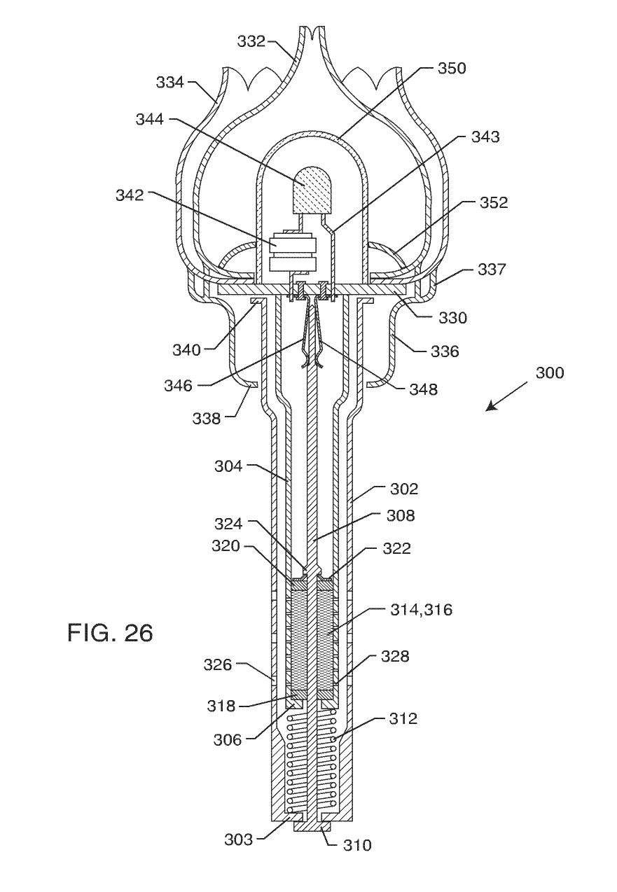

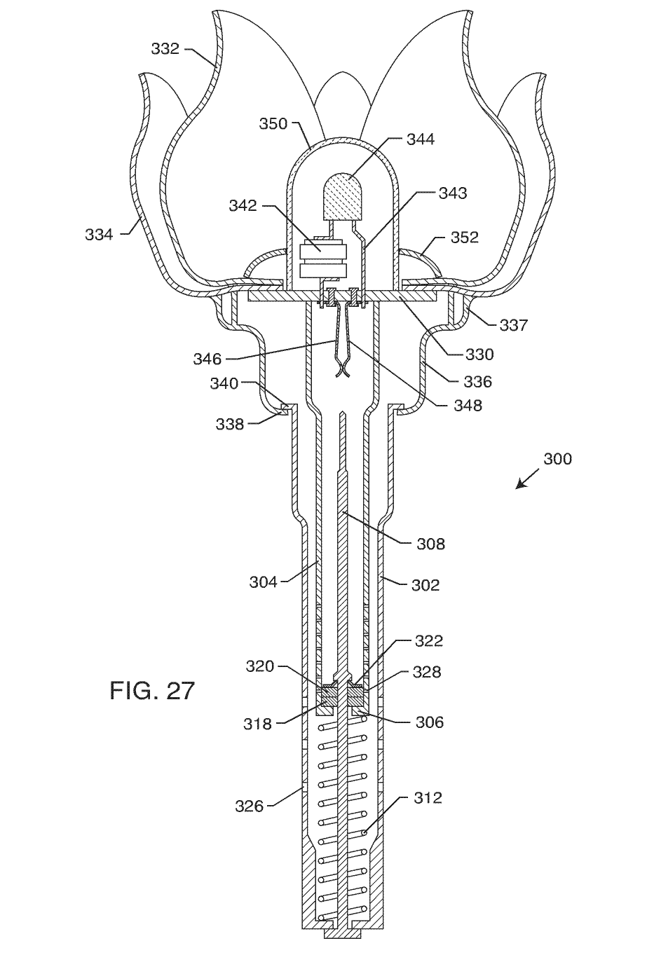

Alternative embodiments of an animated flower are illustrated in FIG. 26 and FIG. 27. In such embodiments, flower 300 includes a stem 302 comprising an elongated tube. A piston 306 is attached to the lower end of an inner stem 304. The inner stem 304 is slidably disposed within the stem 302 and biased upwardly by a helically coiled resilient piston spring 312 positioned in a compressed state between the piston 306 and a stem base 303 at the lower end of the stem 302.

The piston 306 includes an aperture which receives a retaining rod 308 slidably therethrough. The retaining rod 308 comprises an elongated rod within the stem 302, and is typically attached to and projected upwardly from the stem base 303. The stem base 303 can optionally include an aperture to receive the retaining rod 308 therethrough, and the retaining rod 308 can optionally include a flared or enlarged rod head 310, wherein the rod head 310 can be held upwardly against the outer surface of the stem base 303, typically by the bias force of the piston spring 312.

A piston chamber 314, configured to hold an impeding agent 316, is defined within the inner stem 304, the lower extent thereof being the piston 306. The inner stem 304 also functions to transmit the motion of the piston 306 to other members of the flower 300. A lower chamber washer 318 and an upper chamber washer 320 are optionally disposed over the retaining rod 308 within the inner stem 304 as lower and upper bounding surfaces of the piston chamber 314, and can function to retain the impeding agent 316 therebetween. The lower chamber washer 318 can be attached to the piston 306 and slidably receive the retaining rod 308 therethrough. The upper chamber washer 320 can be attached to the retaining rod 308 and be slidably disposed within the inner stem 304. The lower chamber washer 318 and upper chamber washer 320 optionally comprise a resilient material, like felt or rubber, to enable assembly over a retaining knob 324, which is a small barb-like protuberance of the retaining rod 308.

A retaining stop 322, typically a rigid washer positioned on the retaining rod 308 slightly below the retaining knob 324, overlies the impeding agent 316 and upper chamber washer 320 and retains the force of the piston spring 312. The position of the retaining knob 324 on the retaining rod 308 defines the upper extent of the piston chamber 314, and thereby the extension of the inner stem 304 in the opened flower 300. A generally central aperture of the retaining stop 322 optionally includes a resilient member, so that during manufacturing assembly the retaining stop 322 can be pushed downwardly over the upper tip of the retaining rod 308 and snapped below the retaining knob 324.

In one example embodiment, manufacturing assembly comprises the following steps. The piston spring 312, piston 306 and inner stem 304, and lower chamber washer 318 are lowered over the retaining rod 308 into the stem 302 through the open upper end thereof, in that order. The piston 306 and inner stem 304 are subsequently lowered to a starting position in the closed flower 300, as illustrated in FIG. 26, by an externally applied downward force thereon, which compresses the piston spring 312. The impeding agent 316 is then lowered through the open upper end of the inner stem 304 and placed into the piston chamber 314, the size or amount thereof corresponding to the position of the retaining knob 324. Before the release of the externally applied downwardly force from the piston 306 and inner stem 304, the upper chamber washer 320 and retaining stop 322 are lowered over the retaining rod 308 and are durably affixed below the retaining knob 324. Alternatively, the retaining rod 308 can be provided in multiple independent sections, with the section comprising the retaining knob 324 assembled last in the above described sequence, to allow the apertures in all component parts which receive the retaining rod 308 therethrough to be sized to slidably clear only the most narrow part of the retaining rod 308. In such embodiments, the retaining stop 322 provides features and benefits of the upper chamber washer 320, and the piston 306 provides features and benefits of the lower chamber washer 318, thereby obviating the inclusion and use of the upper chamber washer 320 and lower chamber washer 318.

Stem passages 326 comprise apertures in the stem 302 to admit a select liquid therein. Piston chamber passages 328 comprise apertures in the inner stem 304 at the piston chamber 314 to admit the select liquid therein. The piston chamber passages 328 are sized to substantially retain the particles, granules, pellets or unit of the impeding agent 316. A gap or space between the inner diameter of the stem 302 and the outer diameter of the inner stem 304 is sized to allow circulation of the select liquid from the stem passages 326 to the piston chamber passages 328.

Upon manual placement of the lower part of the stem 302 of the closed flower 300, as illustrated in FIG. 26, into a container of the select liquid having a depth thereof sufficient to at least partially immerse the piston chamber 314, the select liquid infiltrates the piston chamber 314 and gradually dissolves the impeding agent 316. The rate of dissolution can be greatly affected by the number and size of the stem passages 326 and piston chamber passages 328 included. The piston 306 and inner stem 304 ascend upwardly from within the stem 302 by the force of the piston spring 312 gradually and controllably at a rate commensurate to the rate of dissolution of the impeding agent 316. As the impeding agent 316 dissolves, the piston 306 and inner stem 304 continue their ascent until the impeding agent 316 has been substantially or fully dissolved, and the lower chamber washer 318 contacts the upper chamber washer 320, as illustrated in FIG. 27. The retaining stop 322 limits the ascent of the piston 306.

A petal hinge stage 330, in one embodiment having a generally flat cylindrical shape, is attached to the upper end of the inner stem 304. The petal hinge stage 330 is an attachment basis of a corolla and other component parts. The petal hinge stage 330 can alternatively comprise the upper end of the inner stem 304, being implemented by an attachment of the corolla directly to the tube of the inner stem 304, without the use of an intermediate member. The corolla is comprised of a plurality of resiliently flexible inner petals 332 and outer petals 334, which are attached by their lower ends to the petal hinge stage 330 and biased in a closed-corolla configuration, as illustrated in FIG. 26. That attachment defines the lower part of the inner petals 332 and outer petals 334 as petal hinges.

The inner petals 332 and outer petals 334 can optionally be attached to the petal hinge stage 330 as groups of petals or as a unit comprising an entire whorl or many whorls of petals. In other words, prior to a manufacturing assembly step of attaching the petals to the petal hinge stage 330, the inner petals 332 and outer petals 334 can be rendered or interconnected to form partial groups of petals or one or more complete whorls of petals.

A petal puller 336 is a generally cup-shaped member, somewhat resembling a receptacle or calyx, with an open base defined by a puller collar 338, disposed slidably around the upper end of the stem 302. The petal puller 336 loosely envelops and conceals the petal hinge stage 330, and when drawn downwardly in relation thereto, as illustrated in FIG. 27, transmits an opening force to the inner petals 332 and outer petals 334.

In one embodiment, the petal puller 336 is connected, by handles 337 attached thereto and projected upwardly therefrom, to the inner petals 332 and outer petals 334 at points thereon slightly beyond the perimeter of the petal hinge stage 330, thereby forming a third-class lever of each inner petal 332 and outer petal 334, the fulcrum of each lever being the petal hinges generally situated at the attachment area of each inner petal 332 and outer petal 334 to the petal hinge stage 330, the input effort of each lever being applied at the connection point of each handle 337 to each inner petal 332 and outer petal 334, and the lever output load being the visually engaging upper rim of each inner petal 332 and outer petal 334.

The distance between the fulcrum and input effort position of each inner petal 332 optionally differs from the distance between the fulcrum and input effort position of each outer petal 334, thereby causing the inner petals 332 and outer petals 334 to open and close at differing rates and to differing extents. Furthermore, to create a more dramatic effect, there can be additional variety in the distances between the fulcrum and input effort position among similar inner petals 332 or outer petals 334.

In one embodiment, the petal attachment handles 337 which are attached to the inner petals 332 optionally pass through apertures in and/or spaces between the outer petals 334. The handles 337, and the attachment points to and apertures thereof through the outer petals 334, are optionally concealed as or by sepals projected upwardly from the outer surface of the petal puller 336. In other embodiments, the petal puller 336 can be attached by the handles 337 to fewer than all the inner petals 332 and outer petals 334, or to only the outer petals 334. The inner petals 332 and outer petals 334 which are not directly attached to the handles 337 can be influenced to fully or partially open through inter-petal attachment cables or other attachments to those inner petals 332 and outer petals 334 which are directly attached to the handles 337. Excess length or slack in the inter-petal attachment cables can be employed to delay the start of opening of those inner petals 332 and outer petals 334 not connected directly to the handles 337. Beyond and between the inner petals 332 and outer petals 334 illustrated, additional layers or whorls of petals are optionally configured and acted upon in a like manner.

As the inner stem 304 advances upwardly from within the stem 302 during the transition of the flower 300 from the closed state to the opened state, the petal puller 336 can be drawn downwardly relative to the petal hinge stage 330 by a stem flange 340. The stem flange 340 halts the ascent of the petal puller 336 relative to the stem 302 by engaging the puller collar 338, as illustrated in FIG. 27. In such embodiments, the puller collar 338 comprises an inwardly projected collar that defines an opening at the base of the petal puller 336 which has an inner diameter slightly greater than the outer diameter of the stem 302. The stem flange 340 comprises a flange projected outwardly from the upper end of the stem 302, the outer diameter thereof slightly greater than the inner diameter of the opening of the puller collar 338.

The puller collar 338 is slidably disposed around the stem 302 below the stem flange 340. The vertical distance that separates the stem flange 340 and puller collar 338 in the closed flower 300, as illustrated in FIG. 26, defines the extent of growth the flower 300 exhibits before the onset of the opening actions of the inner petals 332 and outer petals 334. As the inner stem 304 initially ascends from within the stem 302, the flower 300 appears to grow. The petal puller 336 ascends with the inner stem 304, pulled along by the attachment of the handles 337 to the corolla, until the puller collar 338 contacts the stem flange 340, wherein the ascent of the petal puller 336 is halted, and the apparent growth ceases. However, the inner stem 304 continues to ascend, and thereby lifts the petal hinge stage 330 and the attached inner petals 332 and outer petals 334. The inner petals 332 and outer petals 334 are then pulled open by the restrained petal puller 336. The ascent of the inner stem 304 and attached components is configured to end at the completion of the opening of the inner petals 332 and outer petals 334, as illustrated in FIG. 27.

The system comprising the petal puller 336 and handles 337 constitutes a petal control arm. The petal control arm applies the force to open the corolla at the input effort position of the third-class lever comprising the inner petals 332 and outer petals 334. The puller collar 338 and stem flange 340 together constitute a petal control arm activator. The force applied through the petal control arm is enabled by the action of the petal control arm activator. The space between the puller collar 338 and stem flange 340 in the closed flower 300 constitutes an activator interspace. The activator interspace delays the action of the petal control arm activator during a portion of the ascent of the inner stem 304.

A presentation platform is optionally provided by the petal hinge stage 330, or can be otherwise attached to the top end of the inner stem 304, and is at least partially concealed within the inner petals 332 when the corolla is closed and is revealed when the corolla is open. The presentation platform is optionally fitted with a surprise gift comprising an electronic circuit. Alternatively or additionally, other types of surprise gifts can be attached to the presentation platform. In one embodiment, the electronic circuit comprises one or more batteries 342, a resilient spring metal first switch contact 346, a resilient spring metal second switch contact 348, and an electronic load 344, such as a light-emitting and/or a sound- and/or motion-generating device. Connection between the members of the electronic circuit can be made by conductively attached leads 343 which can also serve as physical supports. The first switch contact 346 and second switch contact 348 are optionally affixed, by rivets or otherwise, to the presentation platform and are optionally biased inwardly so as to normally make contact with each other.

In the closed flower 300, as illustrated in FIG. 26, the first switch contact 346 and second switch contact 348 are separated by the upper end of the retaining rod 308, the upper end of the retaining rod 308 comprising the properties of an electrical insulator, and therefore the electronic circuit is open. As the inner stem 304 ascends during the transition of the flower 300 to the opened state, the first switch contact 346 and second switch contact 348 are pulled upwardly and withdrawn from the stationary retaining rod 308, thereby making electrical contact and closing the electronic circuit, as illustrated in FIG. 27.

A translucent pistil hood 350 or the like is optionally attached to the presentation platform to decoratively cover components of the electronic circuit. Other decorative linings 352 and the like are optionally included to make the internal appearance of the flower 300 more appealing.

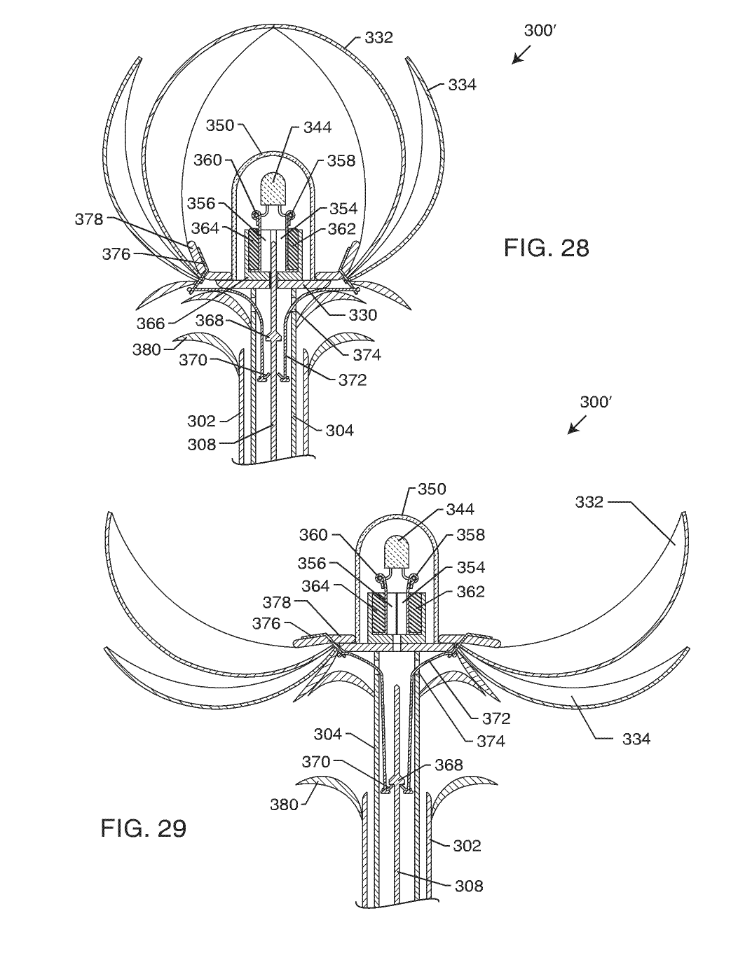

Alternative embodiments of an animated flower are illustrated in FIG. 28 and FIG. 29. In such embodiments, flower 300′ includes a stem 302, inner stem 304, retaining rod 308, petal hinge stage 330, piston, piston spring, piston chamber, impeding agent, stem passages, piston chamber passages, retaining knob, and retaining stop, in form and function similar to flower 300. In this example embodiment, a petal mounting ring 378, typically comprising a resilient and flexible elastic material, such as a closed cell polyurethane foam rubber, is attached, as one annular unit or as one or more independent sections, by an inner part thereof to the perimeter of the petal hinge stage 330. An outer part of the petal mounting ring 378, which can be defined by an upwardly curved or angled perimeter thereof, is optionally extended beyond the petal hinge stage 330. One of more of inner petals 332 and/or outer petals 334 are, by the lower ends thereof, attached to and projected upwardly from the outer part of the petal mounting ring 378, and thereby biased in a closed-corolla configuration.

Petal opening levers 376 have an upper part, for example having the form of a flat hoop or paddle, which is attached to the outer part of the petal mounting ring 378, and a lower part, which is extended below the petal mounting ring 378, typically through an aperture in the petal mounting ring 378 between the inner and outer parts thereof, and projected outwardly. The petal mounting ring 378 functions as one or more hinges to open the inner petals 332 and outer petals 334 relative to the petal hinge stage 330, which hinges are operated by the application of a generally inward force on the lower ends of the petal opening levers 376. One or more petal opening levers 376 can be used to distribute the opening force as needed to pivot open the hinges of the petal mounting ring 378.

The lower ends of the petal opening levers 376 optionally comprise a small loop or other feature whereby a petal cable 372 is attached. Each petal opening lever 376 has attached to it one petal cable 372, which is slidably conducted into the inner stem 304 through a petal cable passage 374, which is an aperture in the wall of the inner stem 304. The petal cable passages 374 and the attachment points of the petal opening levers 376 to the petal cables 372 have elevations that are generally similar, providing an inwardly directed force on the lower ends of the petal opening levers 376 when the petal cables 372 are tensioned. The petal mounting ring 378, petal opening levers 376, petal cable passages 374 and petal cables 372 are optionally concealed from view by leaves or sepals 380.

The ends of the petal cables 372 which are within the inner stem 304 are attached to a petal cable clip 370. The petal cable clip 370 is typically a rigid washer slidably disposed on the retaining rod 308 below a petal opening knob 368, which is a small barb-like protuberance of the retaining rod 308, situated substantially above the petal cable clip 370. In manufacturing, the petal cable clip 370 is optionally assembled below the petal opening knob 368 in a manner similar to that used in the flower 300 to assemble the retaining stop 322 below the retaining knob 324. However, the petal cable clip 370 can be different from the retaining stop 322 of the flower 300 in that the petal cable clip 370 is freely slidable below the petal opening knob 368.

The length of the petals cables 372 sets the vertical distance between the petal cable clip 370 and petal opening knob 368 in the closed flower 300′, as illustrated in FIG. 28. That distance defines the extent of growth the flower 300′ exhibits before the onset of the opening actions of the inner petals 332 and outer petals 334.

As the inner stem 304 ascends from within the stem 302 during the transition of the flower 300′ from the closed state to the opened state, the flower 300′ appears to grow. The petal cables 372 and petal cable clip 370 ascend with the inner stem 304 until the petal cable clip 370 contacts the stationary petal opening knob 368, wherein the ascent of the petal cables 372 and petal cable clip 370 is halted. As the inner stem 304 continues to ascend, the petal cables 372 are tensioned and pull inwardly the lower ends of the petal opening levers 376. As the upper ends of the petal opening levers 376 pivot outwardly, the outer part of the petal mounting ring 378 is rotated downwardly, and the inner petals 332 and outer petals 334 are opened. The ascent of the inner stem 304 and attached components is configured to end at the completion of the opening of the inner petals 332 and outer petals 334, as illustrated in FIG. 29.

In an example embodiment, two levers are applied in opening the inner petals 332 and outer petals 334, a first-class lever and a third-class lever. The first-class lever comprises the petal opening lever 376. The fulcrum thereof is generally situated at the vertex of the angle between the upper and lower parts of the petal opening lever 376, which typically coincides with the vertex of the angle between the inner and outer parts of the petal mounting ring 378. The input effort position of the first-class lever is generally situated at the point where the lower end of the petal opening lever 376 is attached to the petal cable 372. The output load of the first-class lever is the upper part of the petal opening lever 376, which can comprise the hoop or paddle feature. The third-class lever comprises the outer part of the petal mounting ring 378 and the attached inner petals 332 and outer petals 334. The fulcrum thereof is generally situated at the vertex of the angle between the inner and outer parts of the petal mounting ring 378. The input effort position of the third-class lever is generally situated at the area where the outer part of the petal mounting ring 378 is attached to the upper part of the petal opening lever 376. The output load of the third-class lever is the visually engaging upper rim of the inner petals 332 and outer petals 334.

The system comprising the petal opening lever 376 and petal cable 372 constitutes a petal control arm whereby the input effort is applied to the third-class lever comprising the outer part of the petal mounting ring 378 and the attached inner petals 332 and outer petals 334. The petal cable clip 370 and petal opening knob 368 constitute a petal control arm activator whereby the petal control arm is restrained by the stem 302. The space between the petal cable clip 370 and petal opening knob 368 in the closed flower 300′ constitutes an activator interspace, whereby the activation can be delayed during the ascent of the inner stem 304.

A presentation platform is optionally provided by the petal hinge stage 330, or can be otherwise attached to the top end of the inner stem 304, and concealed within the inner petals 332 when the corolla is closed and revealed when the corolla is open. The presentation platform is optionally furnished with a surprise gift comprising an electronic circuit. Additionally or alternatively, other types of surprise gifts can be attached to the presentation platform. With reference again to FIG. 28 illustrating the flower 300′ closed, the upper end of the retaining rod 308 of the flower 300′ is slidably protruded upwardly through an aperture at generally the center of the presentation platform. The electronic circuit is optionally partially housed by a battery holder 366, which in one embodiment can sit loosely on the presentation platform. In one embodiment, the battery holder 366 has four sides, a closed bottom and an aperture through generally the center of the bottom thereof which slidably receives the upper end of the retaining rod 308 therethrough.

The protruded upper end of the retaining rod 308 can be slidably disposed between two inwardly biased members of the electronic circuit and thereby maintain the circuit open. FIG. 28 illustrates one of many possible configurations: separation by the retaining rod 308 of a first battery 354 and second battery 356 positioned in series and subject to an inward bias obtained from the compression of a first pressure pad 362 and second pressure pad 364. In an example embodiment, the first pressure pad 362 and second pressure pad 364 comprise resilient elastic inserts, such as closed cell polyurethane foam rubber pads, coiled compression springs, or other resilient features of the battery holder 366, such as integral clips. A resilient spring metal first battery contact 358 is optionally situated between the first battery 354 and first pressure pad 362 and includes an upwardly projected contact conductively attached to a first lead of an electronic load 344. A resilient spring metal second battery contact 360 is optionally situated between the second battery 356 and second pressure pad 364 and includes an upwardly projected contact conductively attached to a second lead of the electronic load 344.

As the inner stem 304 ascends during the transition of the flower 300′ to the opened state, the battery holder 366 is pulled upwardly therewith, effectively causing the stationary retaining rod 308 to be withdrawn downwardly therefrom. Contact is thereby made between the inwardly biased members of the electronic circuit that had been separated by the insulating retaining rod 308, and the electronic circuit is closed, as illustrated in FIG. 29. In one embodiment, the withdrawal of the retaining rod 308 from the battery holder 366 allows the electronic circuit to be easily removed from the flower 300′. A translucent pistil hood 350 or the like is optionally removably attached to the presentation platform and/or battery holder 366 to decoratively cover the components of the electronic circuit.

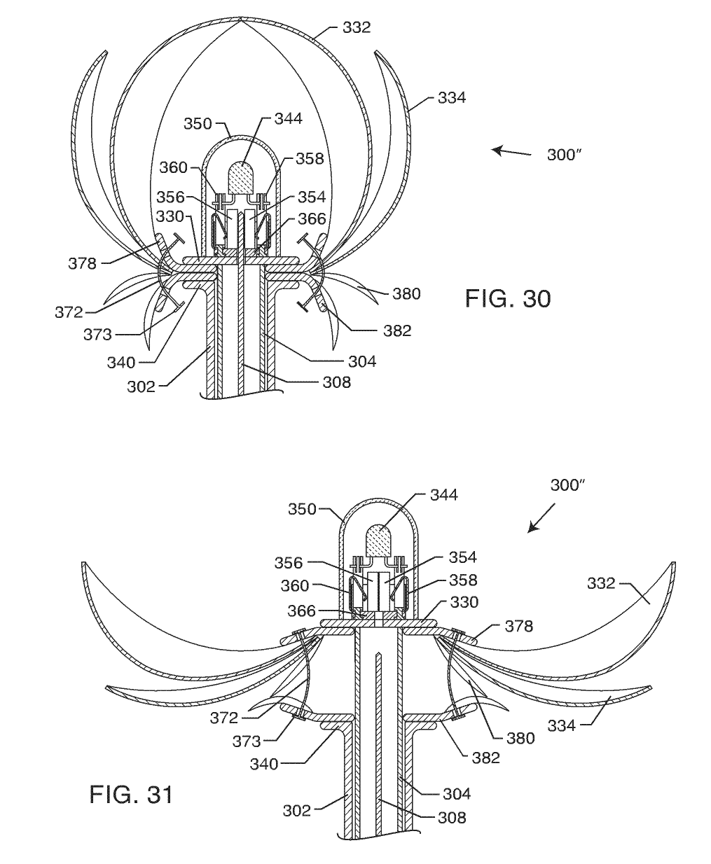

Alternative embodiments of an animated flower are illustrated in FIG. 30 and FIG. 31. In such embodiments, flower 300″ includes a stem 302, inner stem 304, retaining rod 308, petal hinge stage 330, piston, piston spring, piston chamber, impeding agent, stem passages, piston chamber passages, retaining knob, and retaining stop, in form and function similar to flower 300. The flower 300″ also includes a petal mounting ring 378, inner petals 332, outer petals 334, and sepals 380. In this example embodiment, one or more apertures are optionally positioned around the outer perimeter of the petal mounting ring 378 as passageways to slidably conduct therethrough petal cables 372.

A cable pulling ring 382, typically comprising a resilient and flexible elastic material, such as a closed cell polyurethane foam rubber, is attached, as one annular unit or as one or more independent sections, by an inner part thereof to the upper end of the stem 302, typically by the use of a flange 340 as an attachment support. The outer part of the cable pulling ring 382, which is optionally defined by a downwardly curved or angled perimeter thereof, can be extended beyond the flange 340, and optionally includes one or more apertures, which are generally vertically aligned with the similar apertures of the petal mounting ring 378. The apertures in the outer part of the cable pulling ring 382 are passageways which can slidably conduct the petal cables 372 therethrough. The inclusion and use of the cable pulling ring 382 is optionally eliminated by including some or all of the features and benefits thereof into the flange 340.

Each aperture through the outer part of the petal mounting ring 378 and the aperture most closely aligned thereto through the outer part of the cable pulling ring 382 constitute one cable passage set. Typically, each cable passage set employs one petal cable 372. In an example embodiment, the petal cable 372 comprises retaining features 373 at the ends thereof which enable the insertion and retention thereof through apertures of the cable passage set. Alternatively, one of the two apertures of each cable passage set can instead provide a durable attachment to one end of each petal cable 372. Other attachment methods which accommodate slidability of each petal cable 372 through at least one of the apertures of each cable passage set can be used. As yet another option, the petal cable 372 can be durably attached at both apertures of each cable passage set, and can have a length that exceeds the distance between the apertures of the cable passage set.

The length of the petals cables 372 that exceeds the distance between the apertures of the cable passage set in the closed flower 300″, as illustrated in FIG. 30, is cable slack. The amount of cable slack employed defines the extent of growth the flower 300″ exhibits before the onset of the opening actions of the inner petals 332 and outer petals 334.

As the inner stem 304 ascends from within the stem 302 during the transition of the flower 300″ from the closed state to the opened state, the flower 300″ appears to grow. The petal mounting ring 378 ascends with the inner stem 304, increasing the distance between the apertures of each cable passage set, and thereby taking up the cable slack. As the retaining features 373 make contact with the petal mounting ring 378 and cable pulling ring 382, or as the cable slack is otherwise taken up, the increasing separation between the petal mounting ring 378 and cable pulling ring 382 is halted. The continued ascent of the inner stem 304 further tensions the petal cables 372, and then pulls upwardly the outer part of the cable pulling ring 382 and downwardly the outer part of the petal mounting ring 378. As the outer part of the petal mounting ring 378 pivots downwardly, the inner petals 332 and outer petals 334 are opened. The ascent of the inner stem 304 and attached components is configured to end at the completion of the opening of the inner petals 332 and outer petals 334, as illustrated in FIG. 31.

The system comprising the petal cables 372 constitutes a petal control arm whereby the input effort is applied to a third-class lever comprising the outer part of the petal mounting ring 378 and the attached inner petals 332 and outer petals 334, thereby opening the inner petals 332 and outer petals 334. The cable pulling ring 382 constitutes a petal control arm activator whereby the petal control arm is restrained by the stem 302. The cable slack in the closed flower 300″ constitutes an activator interspace, whereby the activation can be delayed during the ascent of the inner stem 304.

When a plurality of petal cables 372 are employed, the petal cables 372 can be configured with varying lengths to provide substantial variations in the delay of opening among the inner petals 332 and outer petals 334. A pleasing sequencing of the opening of the inner petals 332 and outer petals 334 can thus be obtained. Furthermore, the petal cables 372 can be resiliently elastic to allow the shorter petal cables 372 associated with the inner petals 332 and outer petals 334 that have fully opened to stretch somewhat while other inner petals 332 and outer petals 334 continue opening as the ascent of the inner stem 304 approaches conclusion. Variations, irregularities and/or asymmetries in the physical properties, including resilience, shape, material composition, structure, position, connective features and/or attachment location of the units or sections thereof, of the petal hinge stage 330, petal mounting ring 378, cable pulling ring 382 and/or other associated and connected members, can be employed by design to similarly create a pleasing variety in the starting time, rate, extent and/or other manners of opening among the inner petals 332 and outer petals 334.

A presentation platform is optionally provided by the petal hinge stage 330, or can be otherwise attached to the top end of the inner stem 304, and can be furnished with a surprise gift, such as an electronic circuit. An example embodiment includes an electronic load 344, first battery 354, second battery 356, first battery contact 358, second battery contact 360, and battery holder 366. In such embodiments, the first battery contact 358 comprises a resilient spring metal contact attached to the battery holder 366 by rivet or otherwise, thereby providing an inward bias on the first battery 354, and an upwardly projected contact conductively attached to a first lead of the electronic load 344. Likewise, the second battery contact 360 comprises a resilient spring metal contact attached to the battery holder 366 by rivet or otherwise, thereby providing an inward bias on the second battery 356, and an upwardly projected contact conductively attached to a second lead of the electronic load 344. The upper end of the retaining rod 308 separates the first battery 354 from the second battery 356 with an electrical insulator, as illustrated in FIG. 30.

As the inner stem 304 ascends during the transition of the flower 300″ to the opened state, the battery holder 366 is pulled upwardly therewith, effectively causing the stationary retaining rod 308 to be withdrawn downwardly therefrom. Contact is thereby made between the inwardly biased members of the electronic circuit, closing the electronic circuit, as illustrated in FIG. 31. In one embodiment, the withdrawal of the retaining rod 308 from the battery holder 366 allows the electronic circuit to be easily removed from the flower 300″. A translucent pistil hood 350 or the like is optionally removably attached to the presentation platform and/or battery holder 366 to decoratively cover the components of the electronic circuit.

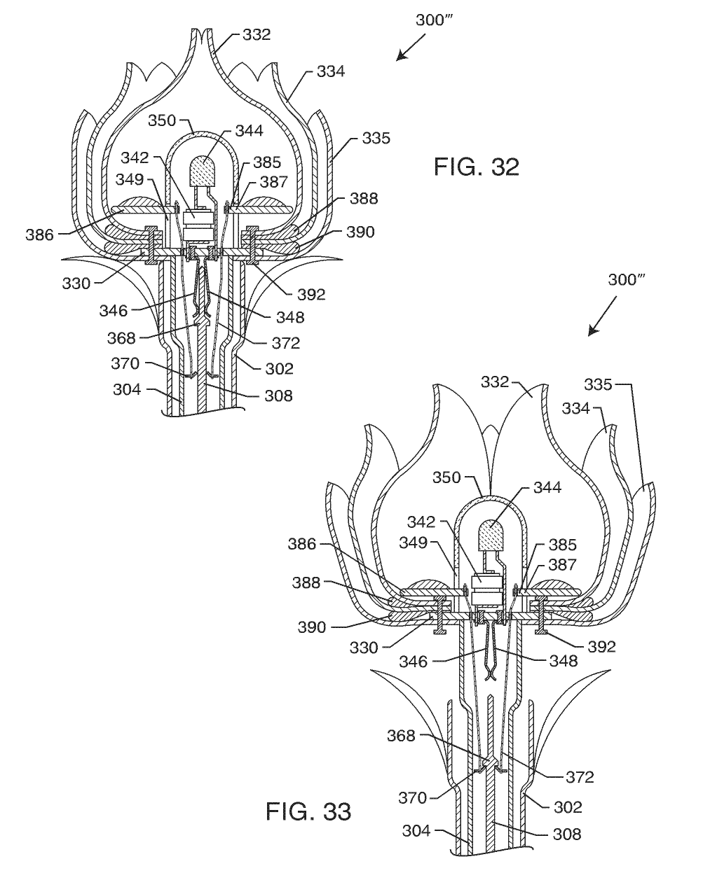

Alternative embodiments of an animated flower are illustrated in FIG. 32 and FIG. 33. In such embodiments, flower 300′″ includes a stem 302, inner stem 304, retaining rod 308, petal hinge stage 330, piston, piston spring, piston chamber, impeding agent, stem passages, piston chamber passages, retaining knob, and retaining stop, in form and function similar to flower 300. The flower 300′″ also includes a petal opening knob 368, petal cable clip 370, petal cables 372, electronic load 344, batteries 342, first switch contact 346, second switch contact 348, and pistil hood 350. The petal hinge stage 330 includes a plurality of apertures that serve as passageways to slidably conduct the petal cables 372 therethrough. These apertures are optionally configured through the petal hinge stage 330 in an unobstructed annular margin situated narrowly within the locus of the attachment of the inner stem 304 thereto. In this example embodiment, the petal cables 372 are concealed from view.

As illustrated in FIG. 32 and FIG. 33, inner petals 332 and outer petals 334 and 335 can be attached to the petal hinge stage 330 by petal rivets 392 or otherwise. The inner petals 332 and outer petals 334 can be separated for aesthetic purposes, typically by a generally toroidally shaped resiliently flexible upper petal spacer 388, such as a closed cell polyurethane foam rubber washer. The outer petals 334 and additional outer petals 335 can be separated by one or more lower petal spacers 390 having characteristics similar to those of the upper petal spacer 388. In the flower 300′″, the pistil hood 350 optionally includes a plurality of vertical slots 349 that slidably receive therethrough a plurality of radial spokes 387 of a petal pusher 386. The upper ends of the petal cables 372 are attached to a typically annular inner hub 385 of the petal pusher 386. The inner hub 385 is disposed within the pistil hood 350.

In one embodiment, the petal pusher 386 comprises a rigid disk-shaped overlay within the corolla, resembling a spoked wheel, that by a downwardly applied force rotates the inner petals 332 and outer petals 334 and 335 outwardly into an open position. The petal pusher 386 optionally comprises an annular outer rim attached to the outer ends of the radial spokes 387. Typically, the inner hub 385 is attached to the inner ends of the radial spokes 387 as a continuous ring.

As the inner stem 304 ascends from within the stem 302 during the transition of the flower 300′″ from the closed state to the opened state, the flower 300′″ appears to grow. The petal pusher 386, petal cables 372 and petal cable clip 370 ascend with the inner stem 304 until the petal cable clip 370 contacts the stationary petal opening knob 368, wherein the ascent of the petal pusher 386, petal cables 372 and petal cable clip 370 is halted. As the inner stem 304 continues to ascend, the petal cables 372 are tensioned, and then, relative to the petal hinge stage 330, draw downwardly the petal pusher 386 within the corolla. The inner petals 332 are outwardly deflected, and therefore opened, by the downward force applied by the outer rim of the petal pusher 386. That downward force of the petal pusher 386 is transmitted by the upper petal spacer 388 and lower petal spacer 390 to the outer petals 334 and 335, respectively. The ascent of the inner stem 304 and attached components is configured to end at the completion of the opening of the inner petals 332 and outer petals 334 and 335 as illustrated in FIG. 33.

In such embodiments, a third-class lever is applied in opening the inner petals 332 and outer petals 334 and 335. Each petal comprises a third-class lever. The fulcrum thereof is generally situated at the attachment area of each petal to the petal hinge stage 330. The input effort position of the third-class levers of inner petals 332 is generally situated at the area where the outer rim of the petal pusher 386 contacts the inner petals 332. The input effort position of the third-class levers of the outer petals 334 is generally situated at the area where the outer rim of the upper petal spacer 388 contacts the outer petals 334. Outer petals 335 can be likewise subject to an input effort through the lower petal spacer 390. The output load of the third-class levers is the visually engaging upper rims of the inner petals 332 and outer petals 334 and 335.

The system comprising the petal pusher 386, petal cables 372, upper petal spacer 388 and lower petal spacer 390 constitutes a petal control arm whereby the input effort is applied to the third-class levers comprising the inner petals 332 and outer petals 334 and 335. The petal cable clip 370 and petal opening knob 368 constitute a petal control arm activator whereby the petal control arm is restrained by the stem 302. The space between the petal cable clip 370 and petal opening knob 368 in the closed flower 300′″ constitutes an activator interspace, whereby the activation can be delayed during the ascent of the inner stem 304.

Variations, irregularities and/or asymmetries in the physical properties, including resilience, shape, material composition, structure, position, connective features and/or attachment locations of the units or sections thereof, of the petal hinge stage 330, petal pusher 386, upper petal spacer 388, lower petal spacer 390, inner petals 332, outer petals 334 and/or outer petals 335 and other associated and connected members, can be employed by design to create a pleasing variety in the starting time, rate, extent and/or other manners of opening among the inner petals 332 and outer petals 334 and 335.

The opening of the corollas of flower 300, flower 300′, flower 300″ and flower 300′″ are described herein. The opened corollas of these flowers are also capable of closing upon a descent of the piston 306 and inner stem 304, and are therefore reusable. Also, the flower 300, flower 300′, flower 300″ and flower 300′″ can be reused with repeated applications of the impeding agent 316 into the piston chamber 314.

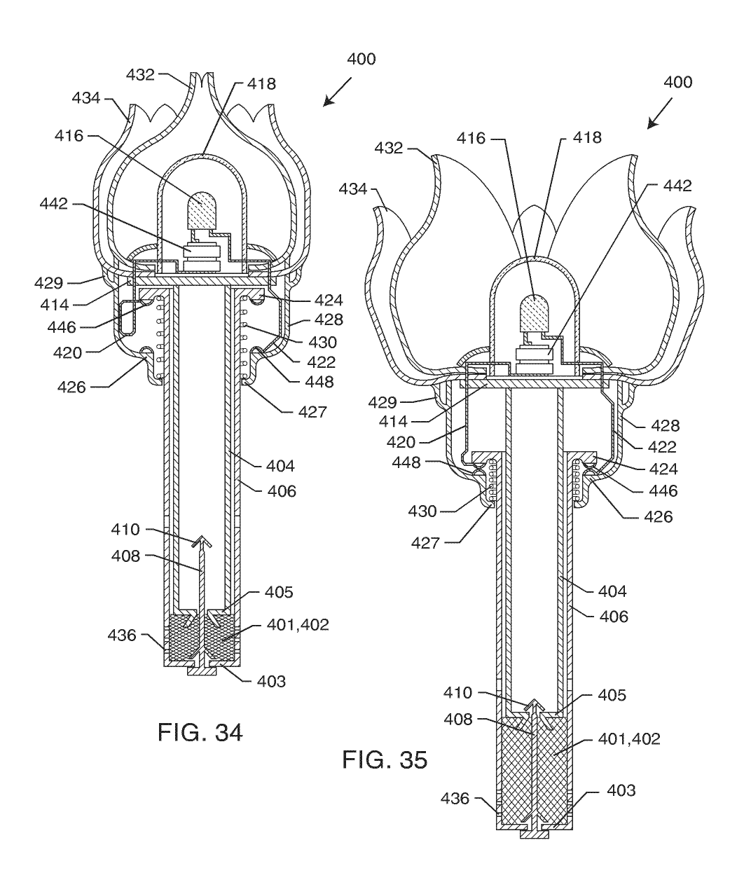

Alternative embodiments of an animated flower are illustrated in FIG. 34 and FIG. 35. In such embodiments, flower 400 includes a stem 406 comprising an elongated tube, and an inner stem 404 slidably disposed within the stem 406. A base at the lower end of the inner stem 404 comprises a piston 405. An aperture through a stem base 403 at the lower end of the stem 406 and an aperture through the piston 405 jointly receive a retaining rod 408 slidably therethrough. The retaining rod 408 is attached to the stem base 403. A barb-like retaining tip 410 at the upper end of the retaining rod 408 defines the extension of the piston 405 and inner stem 404 in the opened flower 400. A stem chamber 401 is defined within the stem 406 between the stem base 403 and piston 405. A substantially dehydrated impellent 402 is situated in the stem chamber 401.

Still referring to the example embodiment illustrated in FIG. 34 and FIG. 35, stem passages 436 comprise apertures in the stem 406 at the stem chamber 401 to admit therein a select liquid. The stem passages 436 are sized to substantially retain the particles, granules, pellets or unit of the impellent 402 and admit the select liquid at a controlled rate. Upon manual placement of the lower part of the stem 406 of the closed flower 400, as illustrated in FIG. 34, into a container of the select liquid having a depth thereof sufficient to at least partially immerse the stem chamber 401, the select liquid gradually infiltrates the stem chamber 401 through the stem passages 436 and is absorbed by the impellent 402, causing it to swell and expand. The rate of expansion can be greatly affected by the number and size of the stem passages 436 included. The piston 405 and inner stem 404 ascend upwardly from within the stem 406 by the force of the expanding impellent 402, and continue to ascend until the piston 405 contacts the retaining tip 410, as illustrated in FIG. 35. The retaining tip 410 limits the ascent of the piston 405 and inner stem 404.

A petal hinge stage 414 is attached to the upper end of the inner stem 404. A plurality of resiliently flexible inner petals 432 and outer petals 434 are attached to the petal hinge stage 414, biased in a closed-corolla configuration, as illustrated in FIG. 34. A petal puller 428 includes a puller collar 426 that slidably surrounds the upper end of the stem 406. The petal puller 428 is attached by handles 429 to the inner petals 432 and outer petals 434 at points thereon slightly beyond the perimeter of the petal hinge stage 414. When drawn downwardly in relation to the petal hinge stage 414, as illustrated in FIG. 35, the petal puller 428 transmits an opening force to the inner petals 432 and outer petals 434.

In such embodiments, a stem flange 424 halts the ascent of the petal puller 428 relative to the stem 406 by engaging the puller collar 426. The puller collar 426 comprises an inwardly projected collar at the base of the petal puller 428 which has an inner diameter slightly greater than the outer diameter of the stem 406. The stem flange 424 comprises a flange projected outwardly from the upper end of the stem 406, the outer diameter thereof slightly greater than the inner diameter of the puller collar 426.

The puller collar 426 is slidably disposed around the stem 406 below the stem flange 424. The vertical distance that separates the stem flange 424 and puller collar 426 in the closed flower 400, as illustrated in FIG. 34, defines the extent of growth the flower 400 exhibits before the onset of the opening actions of the inner petals 432 and outer petals 434. As the piston 405 and inner stem 404 initially ascend from within the stem 406, the flower 400 appears to grow. The petal puller 428 ascends with the piston 405 and inner stem 404 until the puller collar 426 is stopped by the stem flange 424, wherein the ascent of the petal puller 428 is halted, and the apparent growth ceases. However, the piston 405 and inner stem 404 continue to ascend, and thereby lift the petal hinge stage 414 and the attached inner petals 432 and outer petals 434, which are then pulled open by the restrained petal puller 428. The ascent of the piston 405 and inner stem 404 and attached components is configured to end at the completion of the opening of the inner petals 432 and outer petals 434, as illustrated in FIG. 35.

A helically coiled resilient compression spring 430 is optionally positioned around the stem 406 between the stem flange 424 and a lower lip 427 of the puller collar 426. The bias of the spring 430 maintains the flower in the closed state before actuation, and provides a gradually increasing force to slowly open the inner petals 432 and outer petals 434 as the piston 405 and inner stem 404 ascend. Alternatively or additionally, a retaining clip (not illustrated) can be positioned on the retaining rod 408 below or attached to the retaining tip 410. The retaining rod 408 can be extended in length to accommodate the inclusion of a helically coiled resilient compression piston spring (not illustrated) positioned in a compressed state between the retaining clip and piston 405. This piston spring provides an additional bias to maintain the flower 400 in the closed state before actuation and, after the completion of animation activity and as the select liquid is removed from the impellent by evaporation, compresses the impellent, adding some potential energy thereto.

A presentation platform is optionally provided by the petal hinge stage 414, or can be otherwise attached to the top end of the inner stem 404, and can be fitted with an electronic circuit, and/or a surprise gift can be attached thereto. The electronic circuit comprises one or more batteries 442, a flexible first wire 420, flexible second wire 422, upper contact 446, lower contact 448, and electronic load 416, which can be one or more of a light-emitting and/or a sound- and/or motion-generating device. The upper contact 446 can be a resilient annular spring metal contact affixed to the lower surface of the stem flange 424. The lower contact 448 can be a resilient annular spring metal contact affixed to the upper surface of the puller collar 426. In such embodiments, the first wire 420 connects the battery 442 to the upper contact 446, and the second wire 422 connects the electronic load 416 to the lower contact 448.

In the closed flower 400, as illustrated in FIG. 34, the upper contact 446 and lower contact 448 are separated and therefore the electronic circuit is open. As the piston 405 and inner stem 404 ascend during the transition of the flower 400 to the opened state, the lower contact 448 is pulled upwardly until electrical contact is made with the upper contact 446 and the electronic circuit is closed, as illustrated in FIG. 35. A translucent pistil hood 418 or the like can be attached to the petal hinge stage 414 to decoratively cover some of the component parts of the electronic circuit.

Evaporation of the select liquid from the impellent 402, typically through the stem passages 436, shrinks the impellent 402, restores the flower 400 to the closed state and enables reusability. Alternatively, saturation of the impellent 402 and therewith, the extension of the piston 405 and inner stem 404 and the presentation of the opened corolla, can be prolonged indefinitely by occluding the stem passages 436 to prevent evaporation. The occlusion (not illustrated) can be applied by a tight fitting elastic outer sleeve, adhesive tape, viscous putty, or the like.

The petals of flower 300, flower 300′, flower 300″, flower 300′″ and flower 400 are biased in a closed state, and are opened by a generally downward force applied by a petal control arm at an input effort position of a third-class lever comprising the petals. In other embodiments, the petals are biased in an opened state and closed by a generally upward force derived from an ascending piston and applied by the petal control arm at the input effort position of the third-class lever comprising the petals.

In the drawings and illustrations referenced herein, the embodiments are not necessarily drawn to scale, but rather are drawn to enable clear visualization of the component parts while imparting the general appearance of a natural flower. Natural flowers exist in a great variety of types and proportions. Some have short stocky stems. Some can have asymmetric petals, petals that vary widely in shape, only one petal or even petals not readily recognizable as such. Though the term “corolla” is commonly used to describe a plurality of petals, in a flower having one petal, one petal will constitute a corolla.

The drawings in this specification do not limit the invention to only those embodiments that generally resemble the illustrations. For example, the embodiments can be enhanced for additional realism or variety by altering the shapes and proportions of the component parts, or by attaching additional petals, sepals, petioles, leaves, nodes, branches, thorns or the like to the stem, perianth or other parts of the embodiments. Such additional components can be added alone or in combination. The inclusion of some such enhancing features in some of the embodiments herein by drawing and description is illustrative only and not limiting.

Moreover, the invention is not limited to embodiments that are intended to convey the beauty of natural flowers, or faithfully replicate the appearance or proportions thereof. An artificial flower can resemble a natural flower in a general sense without closely resembling a particular species of natural flower. It is contemplated that the various embodiments disclosed herein can be crafted as works of creative art to appear unlike existing natural flowers, or can include unnatural cartoonish features and fantastic embellishments, including a decorative base or stand.

Certain embodiments, though referred to herein throughout the specification and appended claims by the term “flower”, bear little or no resemblance to a natural flower. Likewise, certain components, though identified herein throughout the specification and appended claims by a label that also identifies a part of a natural flower, can take other forms or serve other functions. For example, when practiced for use as a child's toy, the embodiments of the invention disclosed herein can resemble a bivalve mollusk, dinosaur, octopus, boat, mermaid, or the like. In such embodiments, the petal can resemble a shell of the bivalve, jaw of the dinosaur, tentacle of the octopus, sail of the boat, tail of the mermaid, or the like. The stem can resemble a siphon or foot of the bivalve, body of the dinosaur, head and visceral mass of the octopus, hull of the boat, body of the mermaid, or the like. Such embodiments can be operated fully or partially submerged, and the advancing motion of the piston can be employed in a mechanical apparatus, for example, as a means of propulsion. Thus, the invention is not limited to use in artificial flowers as commonly understood.

The use of a flat type, helically coiled type, compression type, expansion type, spiral wound or other type of resilient spring in the embodiments herein is not limiting. A specification of a specific resilient spring type shall be understood as one option only and does not exclude other options. Other spring types or resilient member types can be used in alternative positions and configurations to provide similar functional benefits.

The use of an inner stem slidably disposed within a stem to present flower growth and opening is not limiting. A specification of an attachment of, for example, a corolla to an inner stem shall be understood as one option, and does not exclude other options. For example, instead of an inner stem, an “outer stem” or other alternative configuration of stem sections can be used to provide similar functional benefits as those associated with the embodiments disclosed herein.

The terms “manual” and “manipulation”, refers generally to external interaction with certain embodiments or the component parts thereof. Steps or directions that specify manual handling or manipulation describe one application of an external force by, for example, a human hand, but that force can be provided alternatively or additionally by a tool, automated machine or otherwise.

The term “automatic” describes actions and steps which occur without a generally concurrent input of a commensurate mechanical force provided by manual handling or manipulation. A motion, development, change or occurrence shall be deemed automatic when it proceeds without a generally concurrent input of manual handling or manipulation, the force thereof commensurate in magnitude with the force required to perform the motion, development, change or occurrence. A motion, development, change or occurrence is not automatic if the energy used for the performance thereof is, in full or in large part, provided by concurrent manual handling or manipulation. But manual handling or manipulation can provoke or trigger the actuation of an automatic motion, development, change or occurrence. For example, a motion, development, change or occurrence is automatic if the energy used for the performance thereof is, in full or in large part, drawn from an internal source, such as a battery or resilient spring, which are capable of storing the energy required to produce the desired motion, development, change or occurrence for a substantial time.

Terminology such as, “place,” “placement,” “immersion” and “partial immersion,” used in connection with terminology such as, “container,” “vase,” “water,” “liquid” and “select liquid” refers a use of the embodiments in a manner resembling the handling that is customarily given a natural cut flower, such as the placement of an embodiment of the invention into a container of a select liquid to immerse at least the lower portion thereof. In certain uses, an embodiment is placed into an empty container into which a select liquid is subsequently added. In alternative embodiments, actuation is accomplished by other techniques for exposing the impeding agent or impellent to the select liquid. Such alternatives include, but are not limited to the use of vapor, fog, a spray, sprinkle, shower, flow, stream or partial or full submersion, such as by vase, cup, faucet, sink, hose, rainfall, river, lake, irrigation, water pistol, bowl, pitcher, washing machine, bathtub, swimming pool, or the like.

### CONCLUSION

While the foregoing detailed description discloses several embodiments of the present invention, it should be understood that this disclosure is illustrative only and is not limiting of the present invention. It should be appreciated that the specific configurations and operations disclosed can differ from those described above, and that the methods described herein can be used in contexts other than artificial flowers.

Although these inventions have been disclosed in the context of a certain preferred embodiments and examples, it will be understood by those skilled in the art that the present inventions extend beyond the specifically disclosed embodiments to other alternative embodiments and/or uses of the inventions and obvious modifications and equivalents thereof. In addition, while a number of variations of the inventions have been shown and described in detail, other modifications, which are within the scope of the inventions, will be readily apparent to those of skill in the art based upon this disclosure. It is also contemplated that various combinations or subcombinations of the specific features and aspects of the embodiments may be made and still fall within one or more of the inventions. For example, steps of the method(s) disclosed herein can be performed in an order other than that disclosed in the illustrated embodiments, and additional, fewer, or different steps may be performed and still fall within the scope of the inventions. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above.

I claim:

1. An animated artificial flower device, comprising:
a stem;
a piston movably disposed within the stem and subjected to a bias force, the piston being actuatable to move within the stem at a controlled rate; and
a presentation platform operatively coupled to the piston, the presentation platform being movable relative to the stem and configured to hold a surprise object thereon, wherein said movement of the piston by said bias force causes an upward extension of the platform relative to the stem so as to reveal said surprise object.

2. The device of claim 1, wherein the stem has at least one aperture that allows access to an interior of the stem, a chamber within the stem configured to receive an impeding agent therein through said aperture, the impeding agent comprising a material configured to at least one of: chemically react, effervesce, disintegrate, soften, collapse and break down upon exposure to a liquid.

3. The device of claim 2, further comprising a retaining stop disposed within the stem, the retaining stop configured to oppose the bias force, the impeding agent positionable between the piston and the retaining stop, wherein the effective size of the impeding agent changes via exposure to a liquid introduced into the chamber via the at least one aperture so that the bias force moves the piston toward the retaining stop at a rate substantially proportional to the rate of change of the effective size of the impeding agent, thereby controllably moving the piston relative to the stem.

4. The device of claim 1, further comprising at least one simulated petal moveable between a closed state and an opened state, the at least one petal configured to at least partially conceal the surprise object when in the closed state and to at least partially reveal the surprise object when moved into the opened state, the at least one petal operatively coupled to the piston such that movement of the piston by the bias force actuates a change in the state of the at least one petal.

5. The device of claim 4, further comprising a second stem movably coupled to the stem and operatively coupled to the at least one petal, the second stem movable relative to the stem to simulate flower growth as the petal is moved to the opened state.

6. The device of claim 4, wherein at least a portion of the upward extension of the presentation platform relative to the stem occurs after the at least one simulated petal is moved into the opened state.

7. The device of claim 4, wherein the at least one simulated petal comprises a plurality of simulated petals, at least one of the petals moveable between the closed state and the opened state at a different rate than another of the petals.

8. The device of claim 1, wherein the bias force is applied by a spring disposed within the stem and coupled to the piston.

9. The device of claim 1, wherein the presentation platform comprises a fastening mechanism for removably fastening the surprise object thereon.

10. The device of claim 1, wherein the presentation platform is operatively coupled to a pin, said pin actuatable to change a state of a switch of the surprise object.

11. The device of claim 10, wherein the surprise object is a light-emitting device.

12. A method for operating an animated artificial flower, comprising:
actuating a piston movably disposed within a stem of the artificial flower to move relative to the stem at a controlled rate; and
actuating a presentation platform operatively coupled to the piston to extend upwardly relative to the stem of the artificial flower to reveal a surprise object coupled to the presentation platform.

13. The method of claim 12, wherein actuating the piston comprises exposing an impeding agent disposed within the stem adjacent the piston to a liquid to change the effective size of the impeding agent, thereby causing the piston to move at a rate substantially proportional to the rate of change of the effective size of the impeding agent.

14. The method of claim 13, wherein changing the effective size of the impeding agent comprises causing the impeding agent to at least one of chemically react, effervesce, disintegrate, soften, collapse and break down.

15. The method of claim 12, wherein actuating the piston comprises exposing an impellent agent disposed within the stem adjacent the piston to a liquid to change the effective size of the impellent agent, thereby causing the piston to move at a rate substantially proportional to the rate of change of the effective size of the impellent agent.

16. The method of claim 12, wherein moving the piston comprise moving at least one petal between a closed state, where the surprise object is at least partially concealed, to an opened state where the surprise object is at least partially revealed.

17. The method of claim 16, wherein moving the at least on petal comprises moving a second stem relative to the stem so as to simulate flower growth as the petal moves into the opened state.

18. The method of claim 16, wherein moving the at least one petal comprises moving one of a plurality of simulated petals between the closed state and the opened state at a different rate than another of the plurality of simulated petals.

19. The method of claim 12, wherein actuating the presentation platform comprises upwardly extending the presentation platform relative to the stem at least partially following movement of the petal to the opened state.

20. The method of claim 12, wherein actuating the presentation platform comprises changing a state of a switch of the surprise object to actuate a feature of the surprise object.

21. The method of claim 20, wherein the surprise object comprises a light-emitting device and changing the state of the switch illuminates the light-emitting device.
